(19) United States
(12) Patent Application Publication
(10) Pub. No.: US 2026/0250142 A1
(43) Pub. Date: Aug. 27, 2026

(54) COVALENT SURFACE MODIFICATION OF TWO-DIMENSIONAL METAL CARBIDES

(71) Applicant: The University of Chicago, Chicago, IL (US)

(72) Inventors: VLADISLAV KAMYSBAYEV, Chicago, IL (US); Dmitri V. Talapin, La Grange Park, IL (US)

(21) Appl. No.: 19/648,298

(22) Filed: Apr. 15, 2026

Related U.S. Application Data
(63) Continuation of application No. 17/922,848, filed on May 5, 2021, now Pat. No. 12,649,665.
(60) Provisional application No. 63/020,885, filed on May 6, 2020.

(51) Int. Cl. C01B 32/921; C01B 32/914; C23F 1/10

(52) U.S. Cl. CPC C01B 32/921; C01B 32/914; C23F 1/10; C01P 2004/20

(57) ABSTRACT

Methods for modifying the surface termination of two-dimensional (2D) transition metal carbides (MXenes) are provided. The methods, which allow for versatile chemical modification of the terminating anions via halide exchange or substitution and elimination reactions in molten inorganic salts, provide a processing approach that is widely applicable to MXenes as a broad class of functional materials.

### CROSS-REFERENCE TO RELATED APPLICATIONS

The present application is a continuation of U.S. patent application Ser. No. 17/922,848, filed Nov. 2, 2022, the entire contents of which are incorporated herein by reference, which is a national stage of international patent application number PCT/US21/30860, that was filed on May 5, 2021, which claims the priority benefit of U.S. provisional patent application No. 63/020,885, filed May 6, 2020, the entire contents of which are incorporated herein by reference.

### REFERENCE TO GOVERNMENT RIGHTS

This invention was made with government support under FA9550-18-1-0099 awarded by Defense Advanced Research Projects Agency, DE-SC0019375 awarded by the U.S. Department of Energy, and 1611371 awarded by the National Science Foundation. The government has certain rights in the invention.

### BACKGROUND

MXenes are a large class of two-dimensional (2D) transition-metal carbides and nitrides having applications in supercapacitors, batteries, electromagnetic interference shielding, composites, and catalysts. In contrast to more mature 2D materials, such as graphene and transition metal dichalcogenides, MXenes have chemically modifiable surfaces that offer additional engineerability. MXenes are typically synthesized from a corresponding MAX phases, where M stands for a transition metal element (e.g., Ti, Nb, Mo, V, W, etc.), A stands for a main group element, and X stands for C or N, by selectively etching the main group element A (e.g., Al, Ga, Si, etc.). The etching is usually performed in aqueous hydrofluoric acid (HF) solutions rendering MXenes terminated with a mixture of F, O, and OH functional groups, commonly denoted as Tx. The surface termination of MXene sheets is defined during MAX phase etching. Electrochemical and hydrothermal methods have been applied for etching MAX phases without resorting to HF, but the use of aqueous solutions introduces a mixture of Cl, O, and OH surface groups.

### SUMMARY

Method of making halide anion surface-terminated two-dimensional metal carbides and methods of modifying the surface termination of the halide anion surface-termination two-dimensional metal carbides are provided. Also provided are various two-dimensional metal carbides, which may be made using the methods.

One example of a method of making a halide anion surface-terminated two-dimensional metal carbide includes the steps of: providing a hexagonal layered ternary transition metal carbide having the formula Mₘ₊₁ACₘ, where M is a transition metal, A is a metal element, X represents carbon, and m is 1, 2, or 3; selectively etching the A layer of the hexagonal layered ternary transition metal carbide with a transition metal bromide salt in a molten mixture comprising two or more alkali metal halide salts.

One example of a method of modifying the surface termination of a two-dimensional metal carbide includes the steps of: providing particles of a first two-dimensional metal carbide having surface terminating halide anions; dispersing the particles of the first two-dimensional metal carbide in an alkali halide molten salt bath with an ionic compound having a cation and a non-halide anion, whereby non-halide anions from the ionic compound replace surface terminating halide anions on the first two-dimensional metal carbide to form a second two-dimensional metal carbide comprising surface terminating non-halide anions.

Examples of novel two-dimensional metal carbides that can be made using the methods described herein include: two-dimensional titanium carbides having the formula Ti₃C₂Tₙ or the formula Ti₂CTₙ, where Tis O, S, Se, Te, or NH and n has a value from 1 to 2; two-dimensional titanium carbides having the formula Nb₂CTₙ, where Tis O, S, Se, Te, or NH and n has a value from 1 to 2; two-dimensional metal carbides having the formula Mₘ₊₁CₘX₂, where Mis a transition metal element, X is a surface terminating bromide anion, and n has a value from 1 to 2; two-dimensional metal carbides having the formula Ti₃C₂Br₂, Ti₂CBr₂, Nb₂CBr₂, or Nb₂CCl₂.

### BRIEF DESCRIPTION OF THE DRAWINGS

Illustrative embodiments of the invention will hereafter be described with reference to the accompanying drawings, wherein like numerals denote like elements.

FIGS. 1A-1E show surface reactions of MXenes in molten inorganic salts. FIG. 1A shows schematics for etching of MAX phases in Lewis acidic molten salts and an atomic resolution high-angle annular dark-field (HAADF) image of Ti₃C₂Br₂ MXene sheets synthesized by etching Ti₃AlC₂ MAX phase in CdBr₂ molten salt. The electron beam is parallel to zone axis. FIG. 1B shows energy dispersive X-ray (EDX) elemental analysis (line scan) of Ti₃C₂Br₂ MXene sheets. FIGS. 1C-1D show HAADF images of (FIG. 1C) Ti₃C₂Te and (FIG. 1D) Ti₃C₂S MXenes obtained by substituting Br for Te and S surface groups, respectively. FIG. 1E shows a HAADF image of Ti₃C₂₀₂ MXene stands for the vacancy) obtained by reactive elimination of Br surface groups. All scale bars are 1 nm.

FIGS. 2A-2E show surface groups can induce giant strain in the MXene lattice. FIG. 2A shows local interatomic distances in Ti₂CTₙ MXenes (T=S, Cl, Se, Br and Te) probed by small r region of the atomic pair distribution functions, G(r). The vertical lines show the Ti—C, Ti—T bond lengths and Ti—Ti1 and Ti—Ti2 interatomic distances obtained from a Rietveld refinement of powder XRD patterns (dashed lines) and EXAFS analysis (dotted lines). FIG. 2B shows the unit cells of Ti₂CTₙ MXenes (T=S, Cl, Se, Br) obtained from a Rietveld refinement. FIG. 2C shows dependence of the in-plane lattice constant a (equivalent to Ti—Ti2 distance in FIG. 2A) for Ti₂CTₙ and Ti₃C₂Tₙ MXenes on the chemical nature of the surface group (Tₙ). FIG. 2D shows a proposed unit cell of Ti₂CTe MXene (see FIGS. 24A-24E). FIG. 2E shows biaxial straining of Ti₃C₂Tₙ MXene lattice induced by the surface groups. The in-plane (ε_{∥}) and out-of-plane (ε_{⊥}) strain components are evaluated with respect to the bulk cubic TiC lattice with a_{TiC}=4.32 Å.

FIGS. 3A-3B show electronic transport and superconductivity in Nb₂CTₙ MXenes. FIG. 3A shows temperature-dependent resistivity for cold-pressed pellets of Nb₂AlC MAX phase and Nb₂CCl₂ MXene. Inset: Magnetic susceptibility of Nb₂CCl₂ MXene as a function of temperature. FC and ZFC correspond to the field cooled and zero-field cooled measurements, respectively. FIG. 3B shows temperature-dependent resistivity for the cold pressed pellets of Nb₂CTₙ MXenes. Inset: Resistance as a function of temperature at different applied magnetic fields (0 to 8 T) for the cold-pressed pellets of Nb₂CS₂ MXene.

FIGS. 4A-4C show delamination of multilayer Ti₃C₂Tₙ MXenes. FIG. 4A shows a schematic of a delamination process. FIG. 4B shows a transmission electron microscopy (TEM) image of Ti₃C₂Cl₂ MXene flakes deposited from a colloidal solution. Inset: Fast Fourier transform of the highlighted region showing crystallinity and hexagonal symmetry of the individual flake. FIG. 4C shows X-ray diffraction (XRD) patterns of multilayer MXene and delaminated flakes in a film spin casted on a glass substrate.

FIG. 5A shows the structure of Ti₃C₂Cl₂ MXene can be approximated using P6₃/mmc space group with the two lattice parameters: in-plane, a, and out of plane, c. FIGS. 5B-5C show experimental XRD patterns (Cu Kα, reflection; upper curves), Le Bail fits (upper curves) and the corresponding residues (lower curves) of (FIG. 5B) Ti₃C₂Cl₂ MXene derived from (FIG. 5C) Ti₃AlC₂ MAX phase. The successful MXene synthesis can be visualized from the shift of (0002) and (112̅0) peaks to lower angles compared to that of the parent MAX phase. In the direct space, these changes are reflected by the increase of both a and c lattice parameters. The initial Ti₃AlC₂ MAX phase contains small amounts of bulk fcc-TiCₓ (Fm-3m space group) impurity which propagates into the final MXene product. FIG. 5D shows an atomic-column resolved HAADF image of Ti₃C₂Cl₂ MXene. The electron beam is parallel to [21̅1̅0] zone axis. FIG. 5E shows the EDX elemental line scans of Ti₃C₂Cl₂ MXene using Ti Kα and Cl Kα, which suggest the presence of Cl surface groups on each Ti₃C₂ sheet. Due to their low Z contrast, C atoms could not be observed.

FIG. 6A shows side and top views of the unit cells of Ti₂CCl₂ MXene derived from the Rietveld refinement in FIG. 6C. FIGS. 6B-6E show experimental XRD patterns (Mo Kal, transmission, upper curves) and Le Bail fits (upper curves) of (FIG. 6B) Ti₂CCl₂ MXene derived from Ti₂AlC MAX phase in FIG. 6D and experimental XRD patterns (upper curves) and Rietveld refinements (upper curves) of (FIG. 6C) Ti₂CCl₂ MXene derived from (FIG. 6E) Ti₂AlC MAX phase.

FIGS. 7A-7D show experimental XRD patterns and Le Bail fits of Nb₂CCl₂ MXene (FIG. 7A) derived from Nb₂AlC MAX phase (FIG. 7B). SEM images of Nb₂CCl₂ MXene (FIG. 7D) and Nb₂AlC MAX phase (FIG. 7C). Accordion-like morphology can be observed in the case of Nb₂CCl₂ MXene. FIG. 7E shows the EDX elemental line scans using Cl Kα and Nb Kα confirm presence of Cl surface groups on each Nb₂C sheet.

FIGS. 8A-8C show XRD patterns of the etching products of Nb₂AlC MAX phase in CdCl₂ molten salt as a function of the etching time and temperature. The diffraction peaks belonging to Nb₂AlC MAX phase do not shift during the intermediate etching steps at which both MAX phase and MXene are present. Hence it can be concluded that there is no intermediate Nb₂CdC MAX phase formation. FIG. 8C shows Nb₂CCl₂ MXene starts to form at 650° C. with the appearance of a broad (0002)_{MXene} peak at ~10° 2θ. The advantage of using CdCl₂ is that it has a boiling point of 960° C. compared to 732° C. of ZnCl₂. As a result, CdCl₂ molten salt can etch Nb₂AlC MAX phase into the corresponding Nb₂CCl₂ MXene at 710° C.

FIGS. 9A-9B show X-ray fluorescence (XRF) elemental analysis for the purified Ti₃C₂Cl_{1.5} MXene (approximated as Ti₃C₂Cl₂) obtained through etching of Ti₃AlC₂ in (FIG. 9A) ZnCl₂ and (FIG. 9B) CdCl₂ molten salts. Etching in CdCl₂ results in Ti₃C₂Cl₂ MXene with minimum Cd contamination (~ 1 mol. % w.r.t. Ti) unlike contamination with Zn (10 mol. % w.r.t. Ti) in case of etching in ZnCl₂ molten salt. This is presumably related to the result in FIGS. 8A-8C.

FIG. 10 shows an experimental XRD pattern and corresponding Le Bail fit of Ti₃C₂Br₂ MXene. In contrast to Ti₃C₂Cl₂ MXene for which P6₃/mmc space group can account for all the peaks in the diffraction pattern (FIGS. 5A-5E), Ti₃C₂Br₂ MXene requires addition of P-3 ml space group with a slightly different a lattice parameter.

FIG. 11A shows an experimental XRD pattern (Mo Kα1, transmission, upper curve) and Le Bail fit (upper curve) of Ti₂CBr₂ MXene. FIGS. 11B-11C show atomically resolved (FIG. 11B) STEM-HAADF and (FIG. 11C) low angle annular dark field (LAADF) images of Ti₂CBr₂ MXene and an experimental XRD pattern (upper curve) and Rietveld refinement (upper curve) of Ti₂CBr₂ MXene. FIG. 11E shows the structure of Ti₂CBr₂ MXene derived from FIG. 11D.

FIG. 12A shows an experimental XRD pattern (Cu Kα, reflection, upper curve) and Le Bail fit (overlapping upper curve) of Ti₃C₂ Te MXene derived from Ti₃C₂Br₂ MXene. Ti₃C₂Te MXene was recovered from the salt matrix using anhydrous N₂H₄. FIG. 12B shows the EDX elemental line scans of Ti₃C₂Te MXene using Ti Kα and Te Lα suggest presence of Te surface groups on each Ti₃C₂ sheet.

FIGS. 13A-13B show XPS survey spectra of: (FIG. 13A) Ti₃C₂Br₂ MXene; (FIG. 13B) Ti₃C₂Te MXene. The Br peaks have been replaced with the Te peaks after the surface group exchange in CsBr/LiBr/KBr molten salt. The Cs 3d peak corresponds to either intercalated Cs⁺ ions or residue Cs⁺X⁻ salt.

FIGS. 14A-14F show high resolution XPS spectra (see XPS section for fitting details) of: (FIG. 14A), (FIG. 14C), and (FIG. 14E) Ti₃C₂Br₂ MXene; (FIG. 14B), (FIG. 14D), and (FIG. 14F) Ti₃C₂Te MXene. The Ti—C component binding energy of Ti₃C₂Br₂ MXene (FIGS. 14A, 14C) shifts to a lower value after Br has been substituted for Te²⁻ (FIGS. 14B, 14D). This result is in accordance with Te being less electronegative than Br. The Te 3d region of Ti₃C₂Te MXene (FIG. 14F) can be modelled using two components: Te²⁻ as the major component (83%) and Te in higher oxidation state (probably in the form of Teₙ²⁻) as the minor component (17%).

FIG. 15 shows an experimental XRD pattern and Le Bail fit of Ti₃C₂S MXene derived from Ti₃C₂Br₂ MAX phase. Ti₃C₂S MXene was recovered from the salt matrix using anhydrous hydrazine (black curve) and subsequently washed with aqueous HCl (dark cyan) to remove traces of bulk wz-CdS.

FIG. 16A shows an experimental XRD pattern and Le Bail fit of Ti₃C₂Se MXene recovered from the salt matrix using anhydrous hydrazine and subsequently washed with aqueous HCl to remove traces of bulk zb-CdSe. FIGS. 16B-16C show (FIG. 16B) HAADF and (FIG. 16C) LAADF images of Ti₃C₂Se MXene.

FIGS. 17A-17B show Raman spectra of Ti₃C₂ MXene functionalized with (FIG. 17A) C₁, S, and (FIG. 17B) Br, Se surface groups. The position of the A_{1g} mode corresponding to the out-of-plane vibration of the surface groups is primarily determined by the atomic mass of the surface group with Br and Se resulting in lower frequencies than Cl and S. Similar trend holds for the E_{g} mode corresponding to the in-plane vibration of the surface groups and outer Ti atoms.

FIGS. 18A-18D show experimental XRD patterns and Le Bail fits of: (FIG. 18A) bare Ti₃C₂ MXene; (FIG. 18B) Ti₃C₂(NH) MXene; (FIG. 18C) Ti₃C₂₀ MXene. (FIG. 18D) Raman spectra of the same MXenes measured using 632 nm laser excitation. The E_{g} mode corresponding to the in-plane vibration of the surface groups in 300-400 cm⁻¹ region (grey area) is absent in the case of the bare Ti₃C₂ MXene. The assignment of the vibrational modes (marked with *) of the bare Ti₃C₂ is based on the work of Hu et al. (T. Hu et al., Phys. Chem. Chem. Phys. 17, 9997-10003 (2015).) The appearance of the Raman forbidden (IR allowed) Eᵤ mode at 277 cm⁻¹ is probably related to the disorder present in the stacks of the bare Ti₃C₂ MXene sheets.

FIG. 19A-19B show XPS spectra of Ti₃C₂(NH) MXene. FIG. 19A shows survey spectrum with the highlighted N 1s region. Elemental analysis of this survey spectrum results in Ti: N ratio of 3:1.1. FIG. 19B shows analysis of the high-resolution N 1s spectrum suggests presence of three components. The 396.2 eV peak (59%) belongs to the chemisorbed β-N on Ti surface. The 397.5 eV peak (26%) could correspond to the chemisorbed α-N₂ on Ti surface. The 399.9 eV peak (16%) likely corresponds to N—H bond.

FIGS. 20A-20B show high resolution XPS spectra (see XPS section for fitting details) of Ti₃C₂₀₂ MXene. The Ti—C component binding energy of Ti₃C₂Br₂ MXene (FIGS. 14A-14F) shifts to a lower value after Br⁻ has eliminated with H⁻.

FIGS. 21A-21C show experimental XRD patterns and Le Bail fits of: (FIG. 21A) Bare Ti₂C MXene with the smallest c lattice constant of just ~10.5 Å (Inset shows HAADF image of bare Ti₂C MXene); (FIG. 21B) Ti₂C(NH) MXene; (FIG. 21C) Ti₂CO MXene.

FIG. 22A shows an experimental XRD pattern (Mo Kal, transmission, upper curve) and Le Bail fit (upper curve) of Ti₂CS MXene. FIG. 22B shows an atomically resolved STEM-HAADF image of Ti₂CS MXene. FIG. 22C shows an experimental XRD pattern (upper curve) and Rietveld refinement (overlapping upper curve) of Ti₂CS MXene. FIG. 22D shows a structure of Ti₂CS MXene derived from FIG. 22C.

FIG. 23A shows an experimental XRD pattern (Cu Kα, reflection, upper curve) and Le Bail fit (overlapping upper curve) of Ti₂CSe MXene recovered from the salt matrix using anhydrous hydrazine. FIGS. 23B-23C show (FIG. 23B) HAADF and (FIG. 23C) LAADF images of Ti₂CSe MXene.

FIG. 24A shows an experimental XRD pattern (0.2412 Å, transmission, upper curve) and Le Bail fit (overlapping upper curve) of Ti₂CTe MXene. FIGS. 24B-24C show (FIG. 24B) HAADF and (FIG. 24C) LAADF images of Ti₂CTe MXene. Also shown is an experimental XRD pattern and Rietveld refinement of Ti₂CTe MXene. FIG. 24E shows the structure of Ti₂CTe MXene derived from FIG. 24D.

FIGS. 25A-25D show experimental XRD patterns and Le Bail fits of: (FIG. 25A) Bare Nb₂C MXene with the c lattice constant larger than that of the bare Ti₂C MXene (FIGS. 21A-21C), probably due to the larger ionic size of Nb atoms; (FIG. 25B) Nb₂C(NH) MXene recovered from the salt matrix using anhydrous hydrazine; (FIG. 25C) Nb₂CO MXene. FIG. 25D shows Raman spectra of the same MXenes. The assignment of the vibrational modes (marked with *) of the bare Nb₂C is based on the work of Hu et al. (T. Hu et al., J. Phys. Chem. C 122, 18501-18509 (2018).)

FIGS. 26A-26B show XPS spectra of Nb₂C(NH) MXene. FIG. 26A shows a survey spectrum with the highlighted N Is region. Elemental analysis of this survey spectrum results in Nb: N ratio of 2:1.1. FIG. 26B shows that analysis of the high-resolution N 1s spectrum suggests presence of three components, similar to that of Ti₃C₂(NH). The 396.4 eV peak (64%) belongs to the chemisorbed β-N on Nb surface. The 397.4 eV peak (21%) could correspond to the chemisorbed α-N₂ on Nb surface. The 399.4 eV peak (16%) likely corresponds to N—H bond.

FIGS. 27A-27D show experimental XRD patterns and Le Bail fits of: (FIG. 27A) Nb₂CS₂ MXene recovered from the salt matrix using anhydrous hydrazine; (FIG. 27C) Nb₂CSe MXene recovered from the salt matrix using anhydrous hydrazine and subsequently washed with aqueous HCl to remove traces of bulk zb-CdSe; and STEM-LAADF images of (FIG. 27B) Nb₂CS₂ MXene and (FIG. 27D) LAADF image of Nb₂CSe MXene.

FIG. 28 shows Raman spectra of Nb₂C MXene functionalized with Cl, S and Se surface groups. A trend similar to the case of functionalized Ti₃C₂ MXene (FIGS. 17A-17B) was observed: the position of the A_{1g} and E_{g} mode is primarily determined by the atomic mass of the surface group with Se resulting in lower frequencies than Cl and S.

FIGS. 29A-29B shows XPS survey spectra of: (FIG. 29A) Nb₂CCl₂ MXene; (FIG. 29B) Nb₂CS₂ MXene. The Cl peaks have been replaced with the S peaks after the surface group exchange in CsBr/LiBr/KBr molten salt.

FIGS. 30A-30E show high resolution XPS spectra (see XPS section for fitting details) of: (FIG. 30A), (FIG. 30C), and Nb₂CCl₂ MXene; (FIG. 30B), (FIG. 30D), and (FIG. 30E) Nb₂CS₂ MXene. The Cl 2p peaks disappear after the S²⁻ surface group exchange. The Nb—C component binding energy of Nb₂CCl₂ MXene (FIGS. 30A, 30C) shifts to a lower value after Cl⁻ has been substituted for S²⁻ (FIGS. 30B, 30D). This result is in accordance with S being less electronegative than Cl. S 2p region of Nb₂CS₂ MXene (FIG. 30E) can be modelled using two components: S²⁻ as the major component (70%) and S in higher oxidation state (probably in the form of Sₙ²⁻) as the minor component (30%).

FIGS. 31A-31B show temperature dependent WAXS patterns of: (FIG. 31A) pure KCl/LiCl salt; (FIG. 31B) KCl/LiCl salt with Ti₃C₂Cl₂ MXene. The peaks corresponding to KCl and LiCl salts shift to lower angles at high temperatures, consistent with the expansion of the ionic lattice. The (0001) peaks corresponding to the multi-layer Ti₃C₂Cl₂ MXene remain temperature independent up to 500° C.

FIG. 32 shows WAXS patterns of Ti₃C₂Cl₂ MXene in KCl/LiCl salt with Li₂O added before reaction (black curve) and after reaction at 550° C. for 16 h (grey curve). Temperature dependent (18 to 500° C.) WAXS patterns are shown for Ti₃C₂Cl₂ MXene reacted with Li₂O.

FIG. 33 shows WAXS patterns of Ti₃C₂Cl₂ MXene in KCl/LiCl salt with K₂Se added before reaction (black curve) and after reaction at 500° C. for 24 h (grey curve). Temperature dependent (20 to 500° C.) WAXS patterns are shown for Ti₃C₂Cl₂ MXene reacted with K₂Se.

FIG. 34 shows a zoomed in version of FIG. 2C showing comparison between the experimental and theoretically predicted (J. Lu et al., Nanoscale Advances 1, 3680-3685 (2019), G. R. Berdiyorov, AIP Advances 6, 055105 (2016), Q. Meng et al., Nanoscale 10, 3385-3392 (2018) and D. Wang et al., ACS Nano 13, 11078-11086 (2019)) in-plane a lattice parameters of the light element functionalized Ti₃C₂Tₙ MXene. For the mixed terminated Ti₃C₂Tx MXene obtained via aqueous LiF—HCl method, a is calculated using the Vegard's Law with the stoichiometry determined previously as Ti₃C₂(OH)_{0.06}(F)_{0.25}(O)_{0.84}. (R. Ibragimova et al., ACS Nano 13, 9171-9181 (2019); and M. A. Hope et al., Phys. Chem. Chem. Phys. 18, 5099-5102 (2016).) No theoretical values for NH, Se, Br, and Te terminated Ti₃C₂ MXenes are currently available.

FIGS. 35A-35C show UPS spectra of the valence band region of (FIG. 35A) Nb₂CCl₂ and (FIG. 35B) Nb₂CS₂. There is finite density of states at the Fermi level (set to 0 eV) at non-zero temperature suggesting metal-like behavior for both MXenes. FIG. 35C shows secondary electron cut-off regions of the UPS spectra of Nb₂CCl₂ and Nb₂CS₂ MXenes. In addition to rendering MXenes with tunable transport and superconducting properties (FIGS. 3A-3B), surface groups allow to tune MXenes' work function (WF). The WF of Nb₂CCl₂ MXene measured is 4.3 eV, while that of Nb₂CS₂ MXene is 3.7 eV.

FIG. 36 shows resistance as a function of temperature at different applied magnetic fields (0 to 4.8 T) for the cold pressed pellet of Nb₂CCl₂ MXene. The Tc shifts to lower temperature with the increase in the magnetic field.

FIG. 37 shows resistivity as a function of temperature for the cold pressed pellet of Nb₂CTₓ MXene.

FIGS. 38A-38B show resistivity as a function of temperature for the cold pressed pellet of: (FIG. 38A) Nb₂CO MXene after thermal annealing at 220° C. and 400° C.; (FIG. 38B) Nb₂C(NH) MXene before and after thermal annealing at 220° C., 400° C., and 550° C. The cold pressed pellet of Nb₂COx MXene did not enter the superconducting state even after thermal annealing at 400° C. The cold pressed pellet of Nb₂C(NH) MXene before thermal processing behaves as an insulator, presumably due to the poor electronic coupling between the sheets. After thermal annealing (under vacuum) at 400° C., Nb₂C(NH) MXene becomes a superconductor with a Te of 5.5 K. Additional annealing at 550° C. results in Nb₂C(NH) MXene with a Tc of 7.1 K.

FIG. 39 shows dependence of the upper critical field (μ₀H_{c2}) on the surface group of the superconducting Nb₂CTₙ MXenes. *Nb₂C(NH) MXene pellet was annealed at 550° C. under vacuum (FIG. 37).

FIG. 40 shows a summary of the STEM and XRD derived lattice parameters, interatomic and center-to-center (CtC) interlayer distances for Ti₃C₂Tₙ MXenes. The strain paraments (ε_{⊥}, ε_{∥}) and Poisson ratios (v) were calculated according to Equations (3)-(5). The XRD CtC distances are not available for S, Se, and Te functionalized MXenes due to the presence of intercalated N₂H₄ solvent.

FIG. 41 shows WAXS patterns of the multilayer and Li⁺ intercalated Ti₃C₂Cl₂ MXene. The c-lattice parameter expands after Li⁺ intercalation. Similar interlayer expansion was observed in case of intercalation of desolvated Li⁺ between the MXene layers during cyclic voltammetry experiments.

FIGS. 42A-42D show characterization of delaminated Ti₃C₂Cl₂ MXene. FIG. 42A shows a comparison of EDX spectra (normalized w.r.t. Ti Kα) for multilayer and delaminated MXene. Slight increase in Ti/Cl ratio in delaminated MXenes can be associated with the partial breakage of Ti—Cl bonds. FIG. 42B shows the Raman spectrum of delaminated Ti₃C₂Cl₂ MXene still contains A_{1g} peak associated with the out-of-plane vibration of surface Cl groups. FIG. 42C shows zeta potential is negative for the delaminated MXenes, consistent with the injection of electron after n-BuLi treatment. FIG. 42D shows size distribution of MXene flakes measured by DLS with the average flake size ~300 nm.

FIG. 43A shows XRD patterns of delaminated and multilayer Ti₃C₂S MXene. The MXene film does not contain TiCₓ and CdS impurities present in the multilayer sample. The film's XRD pattern contains only (0002) peak consistent with most flakes aligned parallel to the substrate. FIG. 43B shows the Raman spectrum of delaminated Ti₃C₂S flakes still contains A_{1g} and E_{g} peaks associated with the vibration of surface S groups. FIG. 43C shows 2D GIWAXS pattern of Ti₃C₂S MXene film. FIG. 43D shows 1D line cut along q_{z} of the 2D GIWAXS pattern shows a (0002) peak similar to that in FIG. 43A. FIG. 43E shows 2D GIWAXS pattern of Ti₃C₂Cl₂ MXene film. Inset: a photograph of spin casted film on a glass substrate (scale bar 1 cm). FIG. 43F shows chi integrated intensity for Ti₃C₂S MXene film does not decay to 0 as in case of Ti₃C₂Cl₂ MXene film. This suggests that Ti₃C₂S MXene flakes are not as well aligned as Ti₃C₂Cl₂ flakes.

FIG. 44A shows XRD patterns of delaminated and multilayer Ti₃C₂NH MXene. (0002) peak is shifted to a lower angle in case of Ti₃C₂NH film, consistent with NMF intercalation. However, presence of (101l) and (1120) peaks suggests incomplete alignment of the flakes parallel to the substrate. FIG. 44B shows the Raman spectrum of delaminated Ti₃C₂NH MXene still contains A_{1g} and E_{g} peak associated with the vibration of surface NH groups.

### DETAILED DESCRIPTION

Methods for modifying the surface termination of 2D transition metal carbides (MXenes) are provided. The methods, which allow for versatile chemical modification of the terminating anions via halide substitution and elimination reactions in molten inorganic salts, provide a processing approach that is widely applicable to MXenes as a broad class of functional materials.

The MXenes used in the methods described herein are 2D transition-metal carbides in which a Mₘ₊₁Xₘ structure forms 2D sheets, where M is a transition metal, X is carbon and mis 1, 2, or 3. A MXene is composed of n layers of element X alternatively sandwiched between n+1 layers of element M. The MXenes can be surface terminated with various functionalities, denoted Tₙ (also referred to herein as ligands), where the particular surface termination generally depends on the chemical synthesis used to form the MXenes. Thus, MXenes can be represented by the general formula Mₘ₊₁XₘTₙ. Examples of transition metals (M) that can be present in the MXenes include Ti, Zr, V, Nb, Ta, Cr, Mo, and Sc.

One example of a method of modifying the surface termination of a MXene begins with a metal carbide MXene that is surface terminated with halide anions, such as chloride ions (Cl⁻) and/or bromide ions (Br⁻). Although other halide anions, such as fluoride anions and/or iodide anions can be used as surface terminating anions, the use of chloride or bromide surface terminating anions is advantageous because Cl— and, even more so, Br— terminated MXenes are particularly efficient at engaging in surface reactions in which the halide ions are exchanged for other atoms or functional groups. Examples of halide-terminated MXenes include those having the general formula Mₘ₊₁XₘCl₂ and the general formula Mₘ₊₁CₘBr₂, where m is 1 or 2. In some embodiments of these MXenes, Mis Ti or Nb. However, other transition metal elements can be used.

The MXenes with halide surface termination can be made from hexagonal layered ternary transition metal carbides or nitrides, which may be represented by the general formula Mₘ₊₁AXₘ, where M is a transition metal, A is a metal that is typically a group 13 or group 14 element, X represents carbon or nitrogen, and m is 1, 2, or 3. The ternary transition metal carbides are referred to as MAX phases. Examples of a suitable MAX phase that can be used to make chloride and bromide terminated MXenes are Ti₃AlC₂ or Ti₂AlC. The MAX phases are converted into MXenes by selective etching of the A layer in the MAX phase by an acidic molten halide salt. Examples of molten salts that can be used include cadmium chloride (CdCl₂) and cadmium bromide (CdBr₂) salts. The use of the Lewis acidic bromide salt CdBr₂ is advantageous because it provides a molten salt etching route for the preparation of Br— terminated MXenes, such as Ti₃C₂Br₂ and Ti₂CBr₂ MXenes. Other Lewis acidic bromide salts that can be used include CuBr₂, NiBr₂, and FeBr₂. These salts can also be mixed with eutectic alkali metal halides (LiBr/KBr/CsBr) to lower their melting points.

The etching can be accomplished by forming a molten mixture of a MAX phase and a halide salt at an elevated temperature (e.g., ≥600° C.) for a time sufficient for the etching reaction (e.g., ≥6 hours (h)) to occur. The halide terminated MXene can then be separated from any excess salt and metal. The molar ratio of MAX phase to halide salt in the mixture can be varied over a wide range, but generally the salt will have a higher molar concentration. By way of illustration, the molar ratio of MAX phase to halide salt in the mixture can be in the range from 1:6 to 1:12.

The surface termination of the MXenes is modified by dispersing particles of the halide anion surface terminated MXenes in an inorganic molten salt bath to which a reactive ionic compound is added. Prior to the modification of the surface termination, the MXenes may be washed to remove residual metal or any other impurities left over from the methods used to make them in order to provide a pure or substantially pure halide-terminated MXene. The ionic compound used in the modification has a cation and a non-halide anion. In the molten salt bath, the non-halide anions partially or completely replace the surface-terminating halide anions on the MXene to form an MXene that is partially or completely surface terminated with the non-halide anions. By way of illustration, in a partial ion exchange, at least 50%, at least 70%, at least 80%, at least 90%, or at least 99% of the surface-terminating halide anions may be exchanged with non-halide surface-terminating anions.

In some examples of the methods, the ionic compound that is added to the molten salt bath acts as an ion exchange additive, whereby non-halide anions from the ionic compound exchange with halide anions, thus establishing covalent bonding with the MXenes. Examples of non-halide anions that can exchange with the surface-terminating halide anions include chalcogenide anions, such as O²⁻, S²⁻, Se²⁻, and Te²⁻. Examples of ionic compounds that include chalcogenide anions include metal salts of the chalcogenides. These include lithium chalcogenide salts, such as Li₂O, Li₂S, Li₂Se, and Li₂Te. Amide ions are another example of a non-halide anion that can be used in a substitution reaction with the halide-terminated MXene. Ionic compounds that include amide ions include sodium amide (NaNH₂).

In some examples of the methods, the ionic compound that is added to the molten salt bath can engage in an elimination reaction in which anions from the compound first replace halide anions terminating the MXenes and then the new anions get reductively-eliminated from the surface producing bare MXenes. Examples of non-halide anions that can be used in an elimination reaction with the halide-terminated the MXene include hydride ions. Ionic compounds that include hydride ions include lithium hydride (LiH).

The molten salt bath is composed of at least one molten alkali halide salt. However, eutectics of two or more molten alkali halide salts can be used. The use of an alkali halide molten salt bath is advantageous because the MXene surface exchange reactions typically require a temperature of 300° C. or greater, and such high temperatures are difficult to achieve using traditional solvents. By way of illustration, various embodiments of the surface exchange reactions can be carried out at temperatures in the range from 300° C. to 700° C. In contrast to traditional solvents, alkali metal halides have high-temperature stability, are able to solubilize high concentrations of various ionic compounds, and have wide electrochemical windows. Suitable alkali halide mixtures include CsBr—LiBr—KBr mixtures and KCl—LiCl mixtures. The halide of the alkali halide salt bath may be chosen to match the halide termination of MXene. Such matching may avoid the introduction of undesired halide impurities in the final product. However, the halide of the alkali halide salt bath and the halide of the MXene need not be the same.

As demonstrated in the following Example, the methods described herein are able to form MXenes with unique structural and electronic properties. For example, the surface terminating groups can be used to control interatomic distances in the MXene lattice and to impart MXenes, such as niobium carbide MXenes (e.g., Nb₂CCl₂, Nb₂C(NH), Nb₂CS₂, and Nb₂CSe) with superconductivity. As such, these MXenes have uses in Josephson Junctions and other superconducting circuit elements at superconducting temperatures.

### EXAMPLE

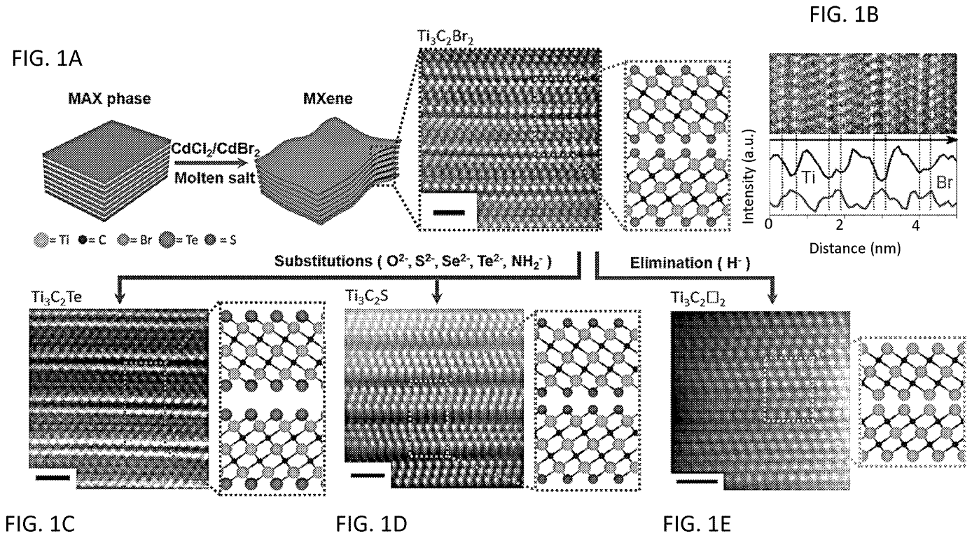

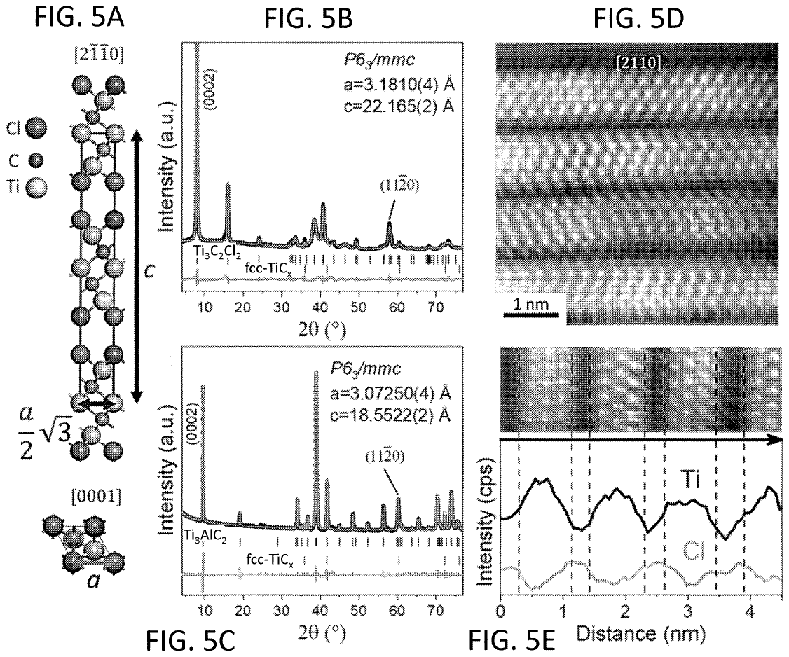

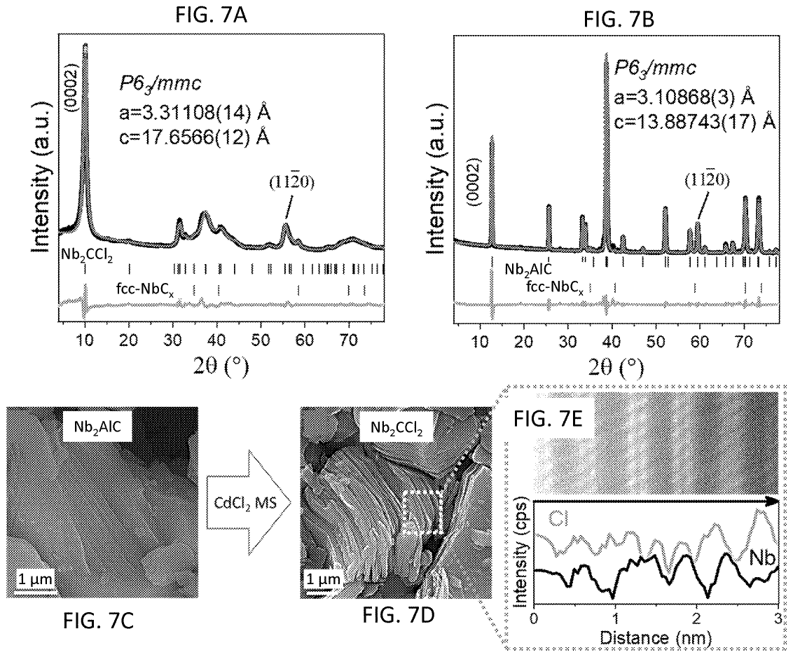

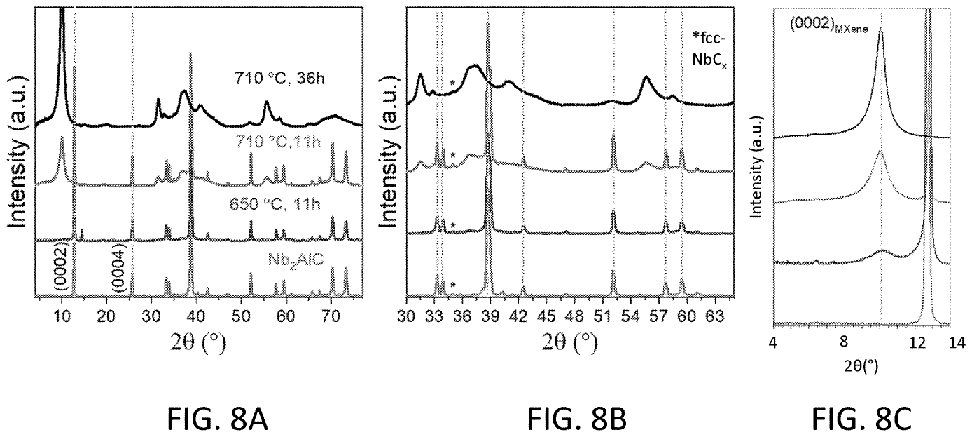

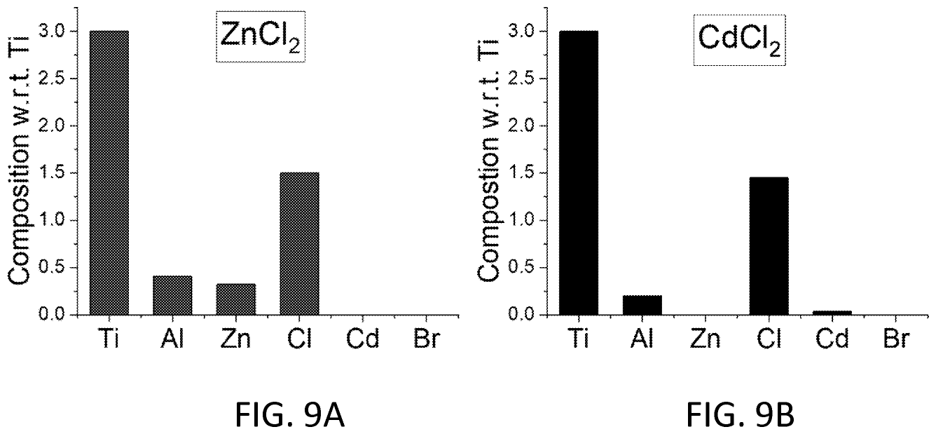

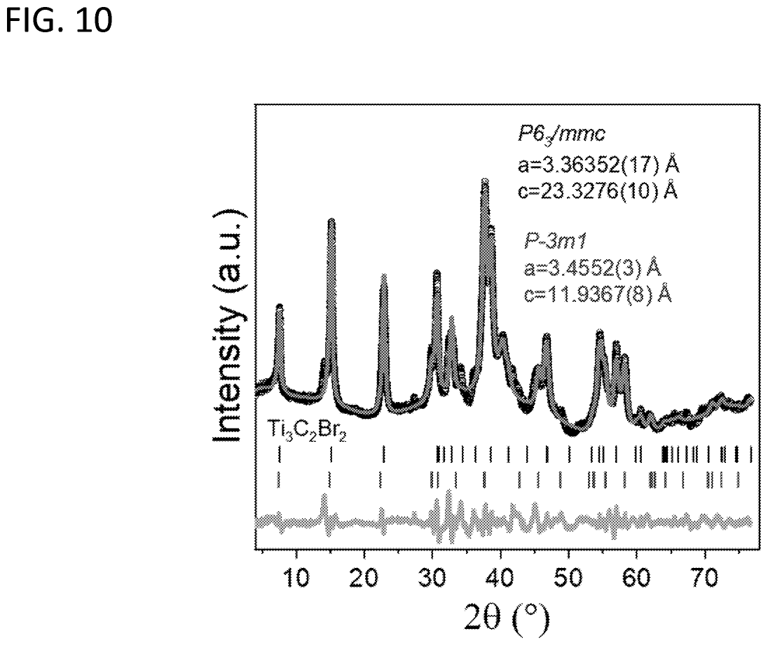

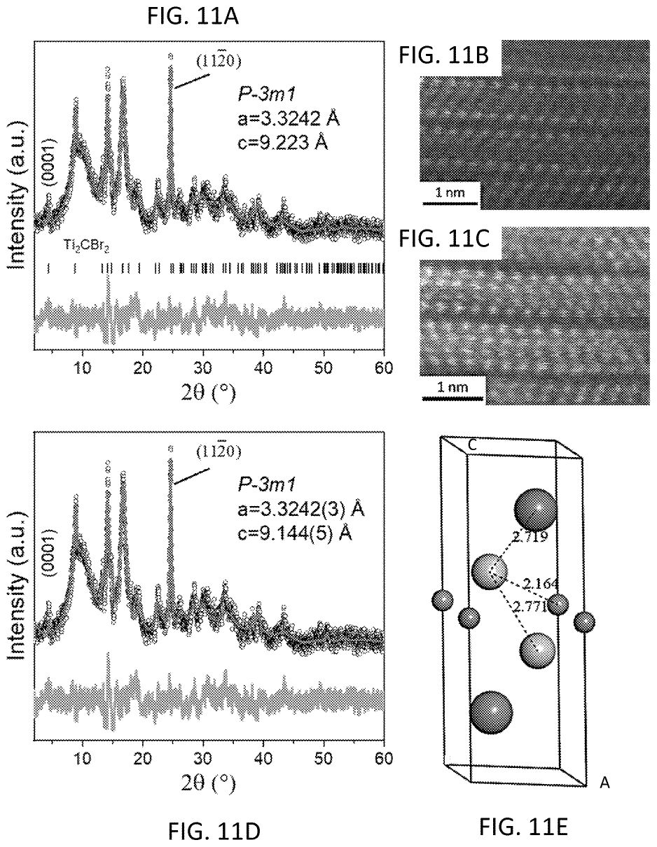

This Example describes the synthesis of Ti₃C₂Cl₂, Ti₂CCl₂, and Nb₂CCl₂ MXenes from Ti₃AlC₂, Ti₂AlC, and Nb₂AlC MAX phases in CdCl₂ molten salt (FIGS. 5A-5E, 6A-6E, 7A-7E, 8A-8C, and 9A-9B). The use of Lewis acidic CdBr₂ allowed for the extension of the molten salt etching route beyond chlorides to prepare the first Br-terminated Ti₃C₂Br₂ and Ti₂CBr₂ MXenes from Ti₃AlC₂ and Ti₂AlC MAX phases (FIGS. 1A-1B, and FIG. 10 and FIGS. 11A-11E). The morphology, structure, and composition of all new MXenes were characterized using high-resolution scanning transmission electron microscopy (STEM), Raman spectroscopy, and a combination of x-ray methods, including energy-dispersive elemental mapping, diffraction (XRD), atomic pair distribution function (PDF), fluorescence (XRF), extended x-ray absorption fine structure (EXAFS), and photoelectron spectroscopy (XPS).

The transition metal atoms from the outer layers of MXene sheets (Ti, Mo, Ta, V) form relatively weak M-Cl and M-Br bonds, in comparison to M-F and M-OH bonds typical for MXenes with Tx surface groups. This point can be demonstrated by the enthalpies of formation for TiBr₄ (−617 kJ mol⁻¹), TiCl₄ (−804 KJ mol⁻¹) vs. TiF₄ (−1649 KJ mol⁻¹), as well as by direct comparison of the bond energies (Table 1). Strong Ti—F and Ti—O bonds make it difficult to perform any post-synthetic covalent surface modifications of MXenes. In contrast, Cl- and Br-terminated MXenes with labile surface bonding act as versatile synthons for further chemical transformations.

TABLE 1
Summary of the bond dissociation energies for M—O and
M—X bonds relevant for this example.

| | Bond dissociation |
|---|---|
| | energy at 298 K |
| Bond | (kJ/mol) |
| Ti—O | 666.5 ± 5.6 |
| Ti—F | 569 ± 33 |
| Ti—Cl | 405.4 ± 10.5 |
| Ti—Br | 373 |
| Nb—O | 726.5 ± 10.6 |
| Nb—Cl | 393 |
| Nb—Br | 347 |

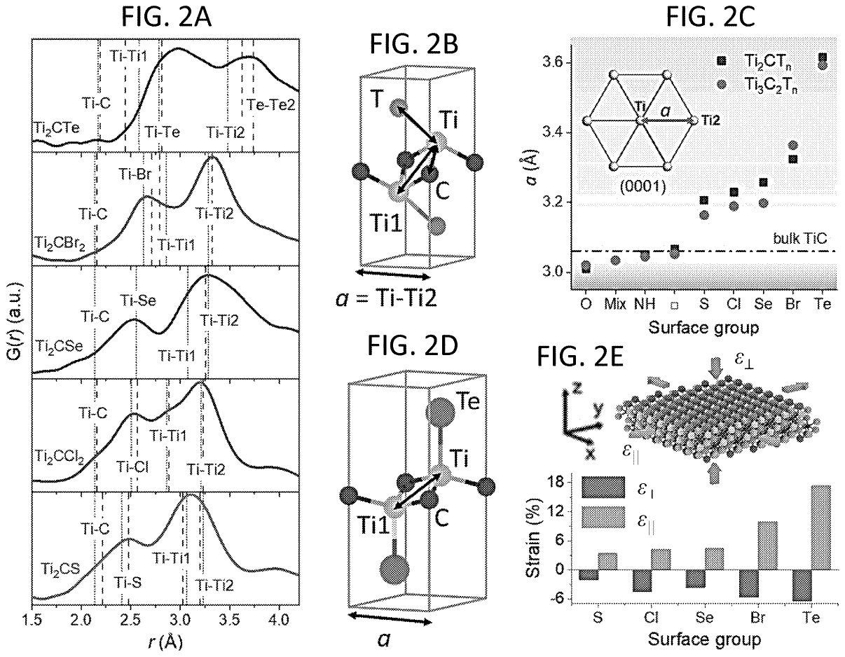

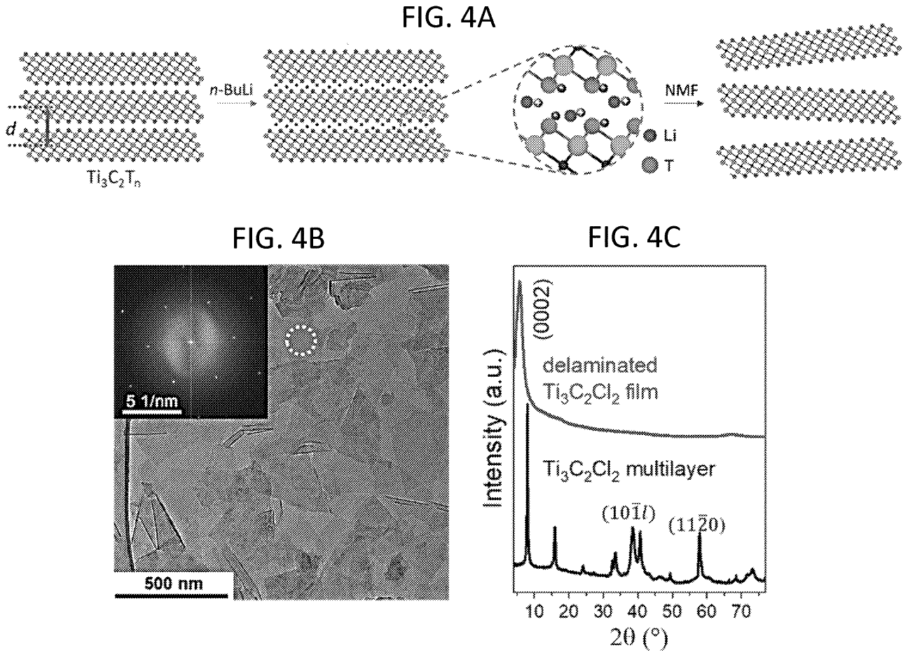

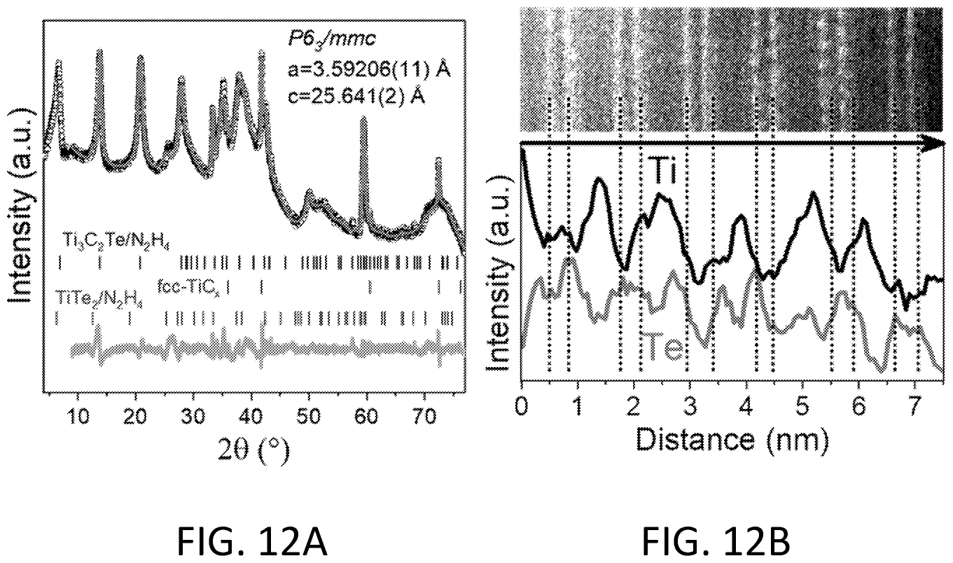

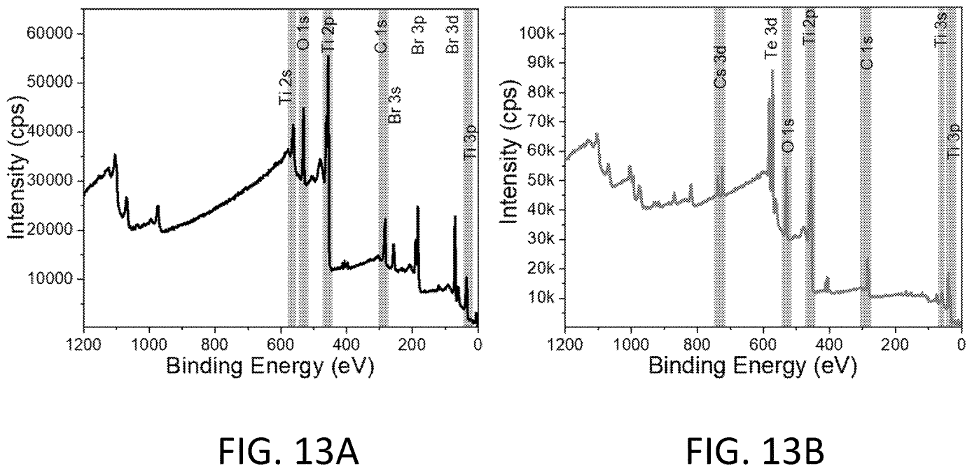

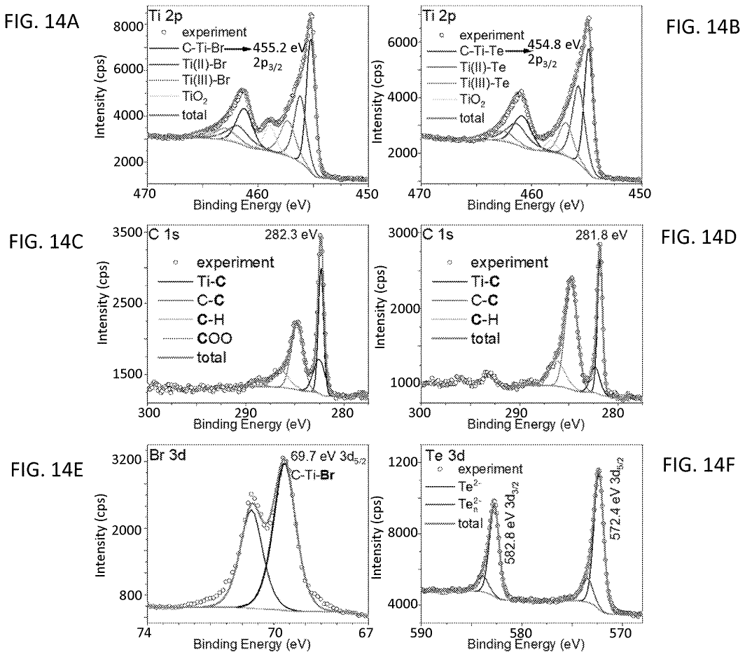

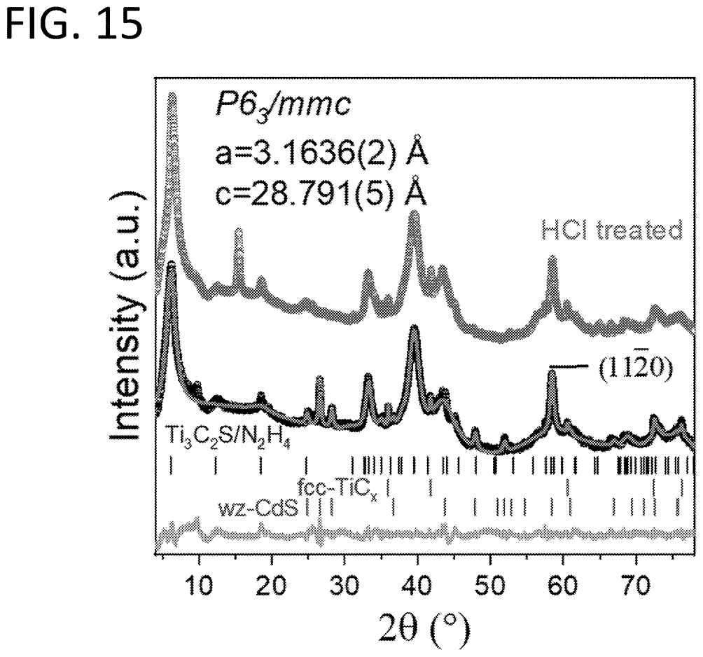

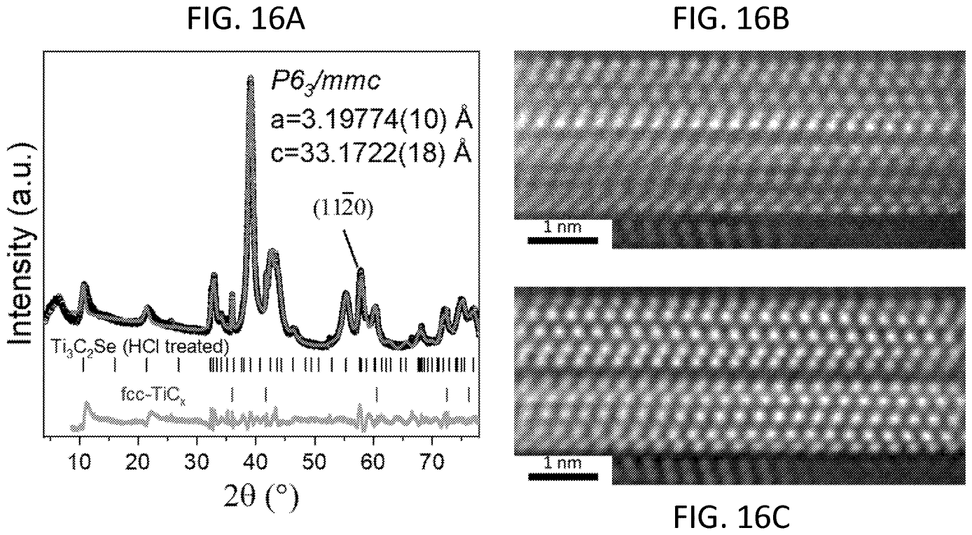

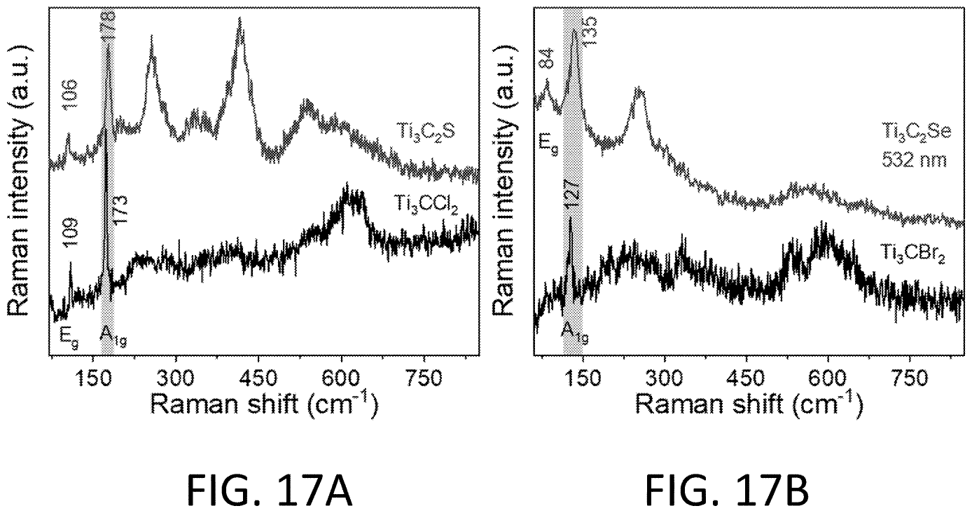

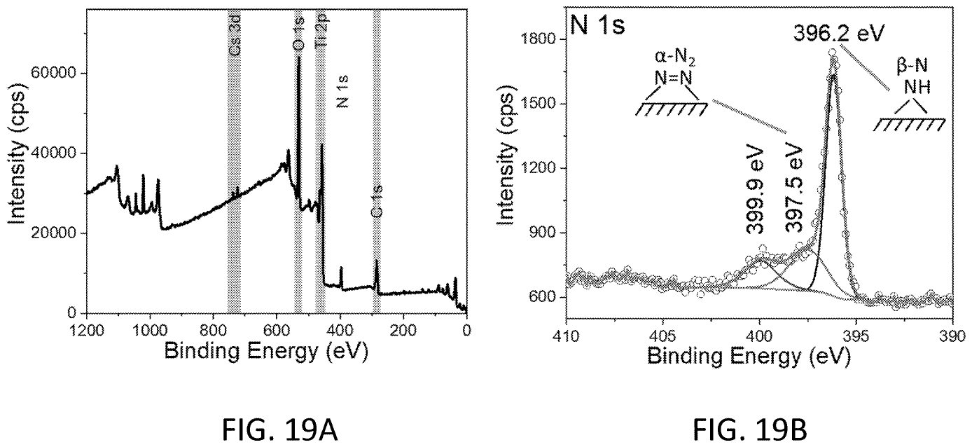

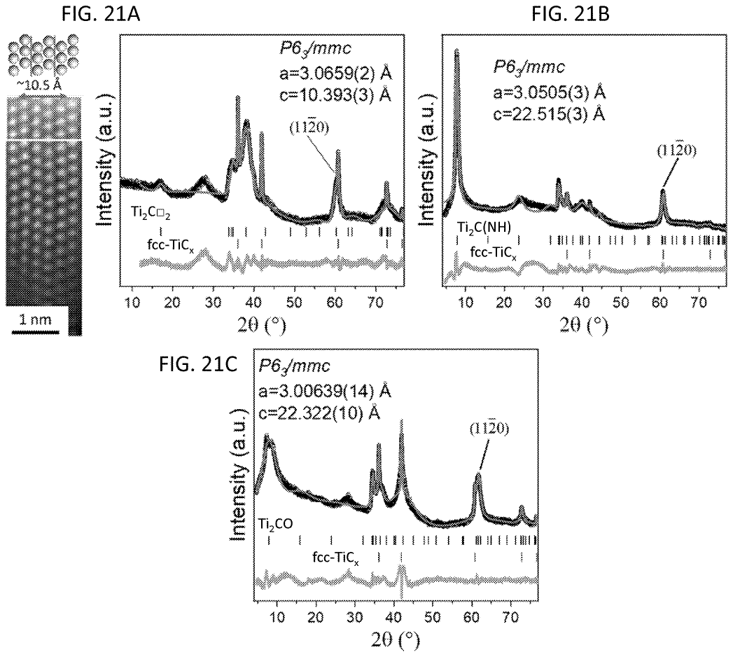

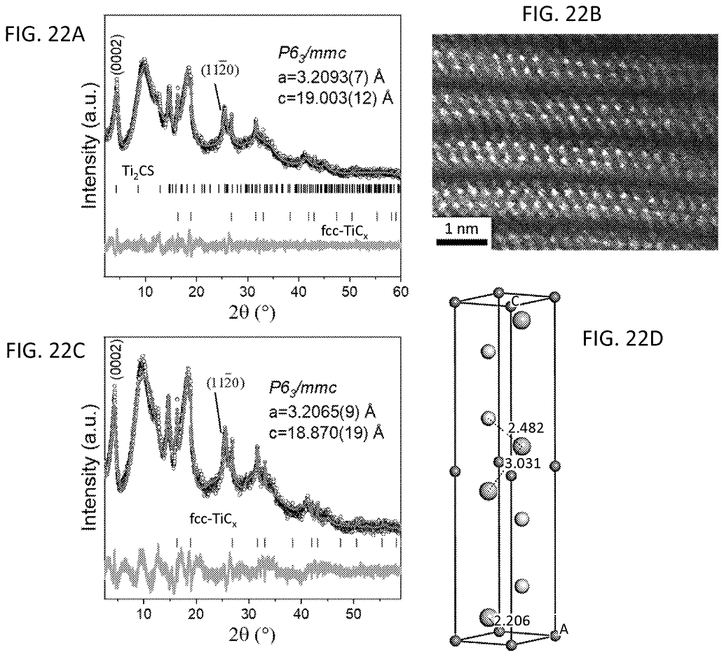

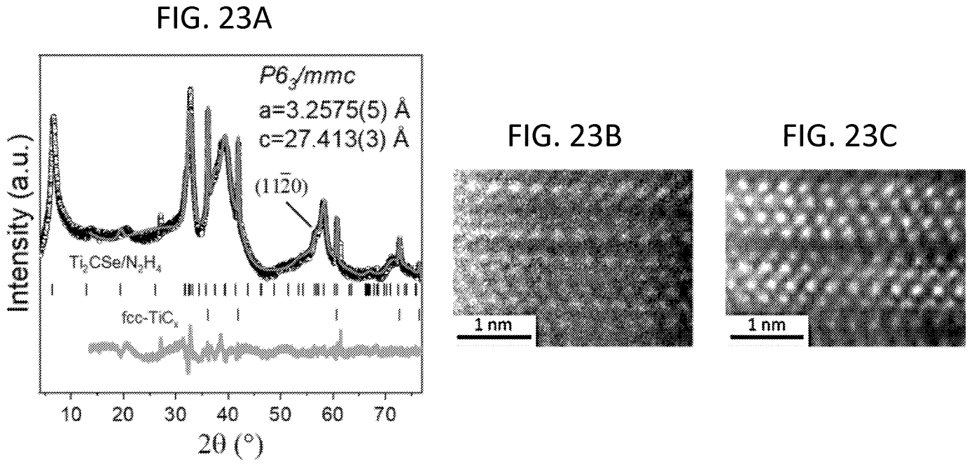

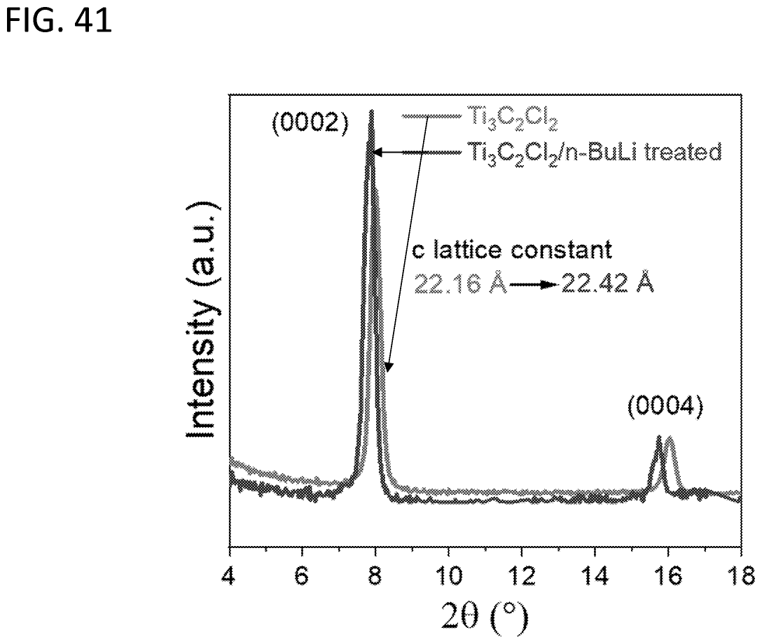

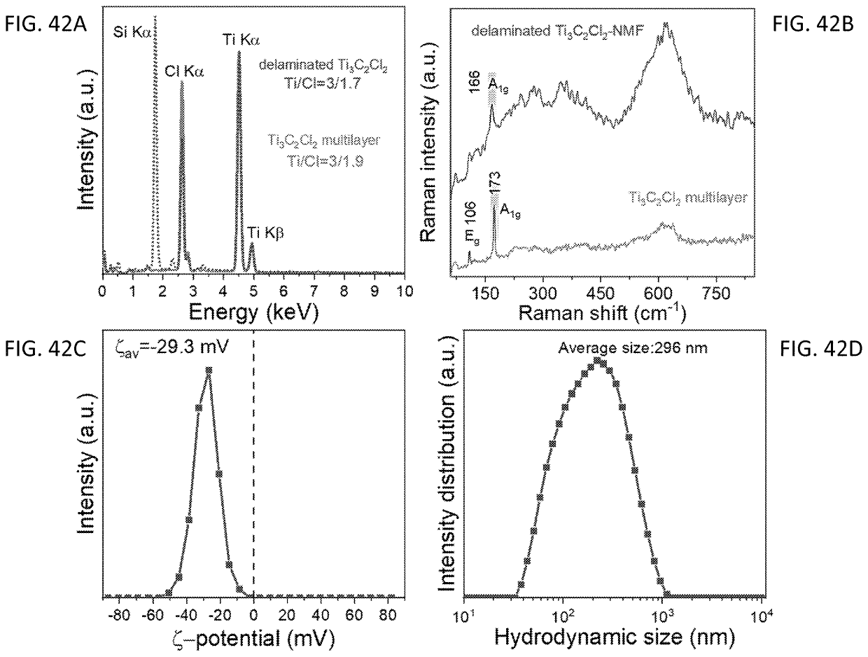

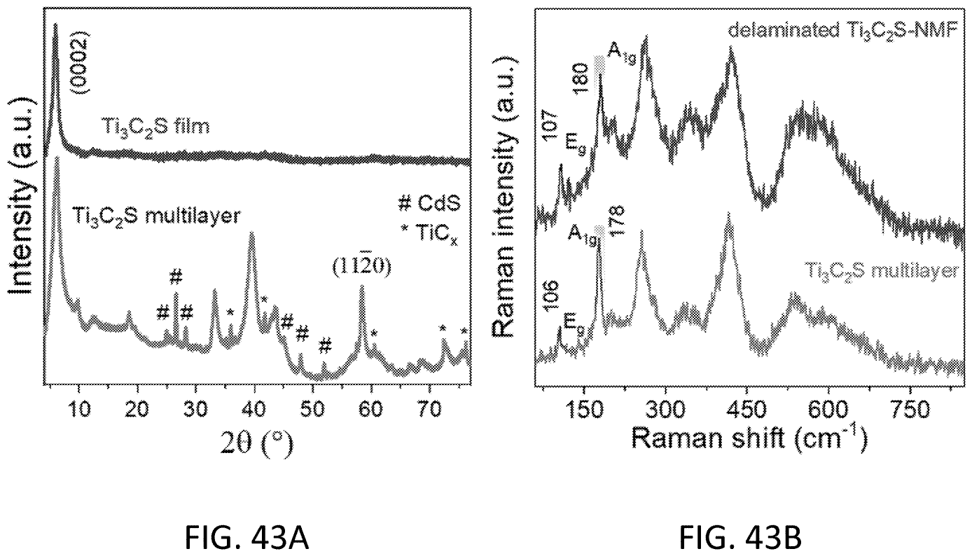

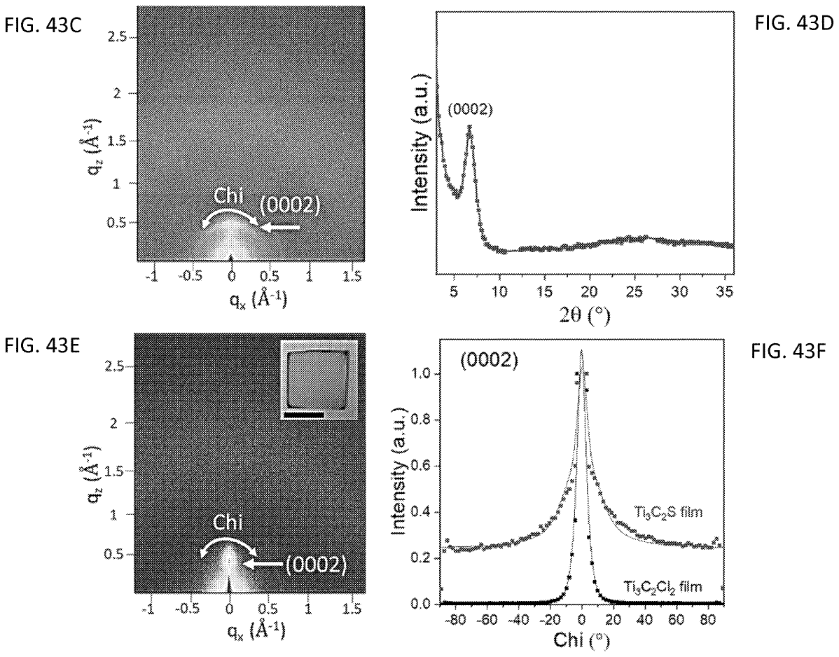

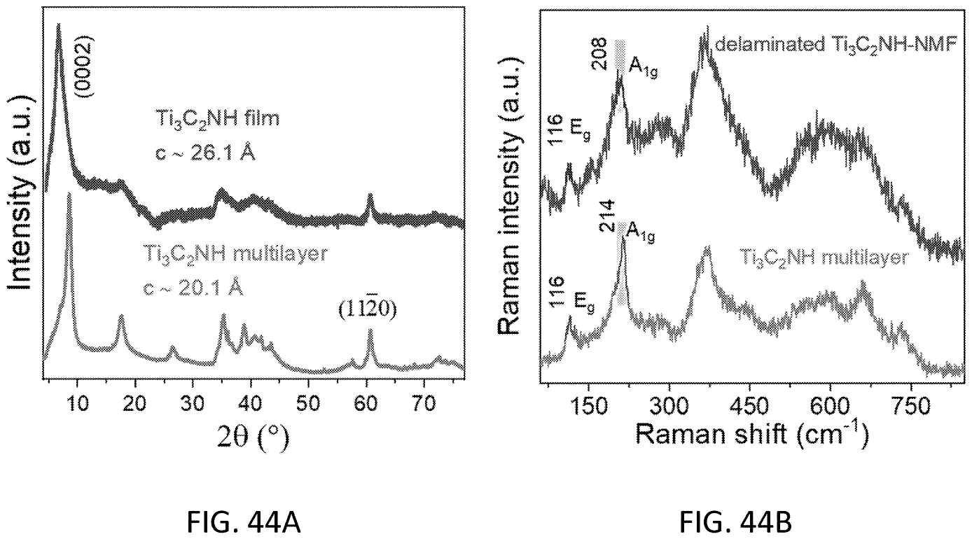

MXene surface exchange reactions typically require temperatures of 300° C. to 600° C., which are difficult to achieve using traditional solvents. Therefore, molten alkali metal halides were used as solvents. For example, Ti₃C₂Br₂ MXene (FIG. 1A) dispersed in CsBr/KBr/LiBr eutectic (m.p. 236° C.) can react with Li₂Te and Li₂S to form new Ti₃C₂Te (FIG. 1C and FIGS. 12A-12B, 13A-13B, and 14A-14F) and Ti₃C₂S (FIG. 1D and FIG. 15) Mxenes, respectively. The reactions of Ti₃C₂Cl₂ and Ti₃C₂Br₂ with Li₂Se, Li₂O, and NaNH₂ yielded Ti₃C₂Se, Ti₃C₂₀, and Ti₃C₂(NH) MXenes, respectively (FIGS. 16A-16C, 17A-17B, 18A-18D, 19A-19B, and 20A-20B). Similar covalent surface modifications can be achieved for Ti₂CCl₂, Ti₂CBr₂, and Nb₂CCl₂ MXenes (FIG. 2A and FIGS. 21A-21C, 22A-22D, 23A-23C, 24A-24E, 25A-25D, 26A-26B, 27A-27D, 28, 29A-29B, and 30A-30E). The ability to perform surface exchange reactions on the thinnest MXenes demonstrates that the 2D sheets stayed intact during all stages of the transformation. The exact metal/surface group elemental ratios for new MXenes were close to the expected values, as summarized in Table 2. It should be noted that Ti₃C₂ Tₙ MXenes, where Tis Cl, S, or NH, can be successfully delaminated into single layer individual sheets. (FIGS. 4A-4C and FIGS. 41, 42A-42D, 43A-43F, and 44A-44B.)

TABLE 2
Summary of the metal to surface group (M/T) elemental ratios
for the MXenes used in this example. EDX elemental mapping
was performed in SEM (marked with *) and STEM. Light element
(NH, O) terminated MXenes and bare MXenes are not included. XRF
analysis was performed on the sample area of 79 mm².

| | M/T ratio | M/T ratio |
|---|---|---|
| Material | EDX | XRF |
| Ti₃C₂Cl₂ | 3/1.9* | 3/1.5 |
| Ti₃C₂Br₂ | 3/1.8* | 3/1.8 |
| Ti₃C₂S | 3/1.1 | 3/1.1 |
| Ti₃C₂Se | 3/1.1 | 3/1.2 |
| Ti₃C₂Te | 3/1.0 | 3/1.2 |
| Nb₂CCl₂ | 2/1.7* | 2/1.7 |
| Nb₂CS₂ | 2/1.6 | 2/1.7 |
| Nb₂CSe | 2/1.0* | 2/1.0 |
| Ti₂CCl₂ | 2/1.7 | 2/1.5 |
| Ti₂CBr₂ | 2/1.6 | 2/2.0 |
| Ti₂CS | 2/1.2* | 2/1.2 |
| Ti₂CSe | 2/1.1* | 2/1.2 |
| Ti₂CTe | 2/1.2 | 2/1.2 |

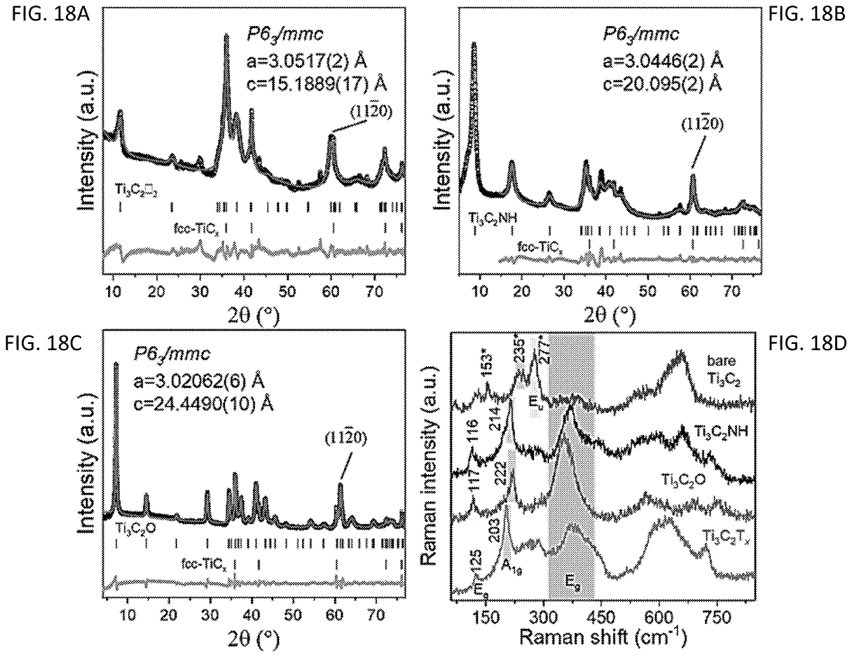

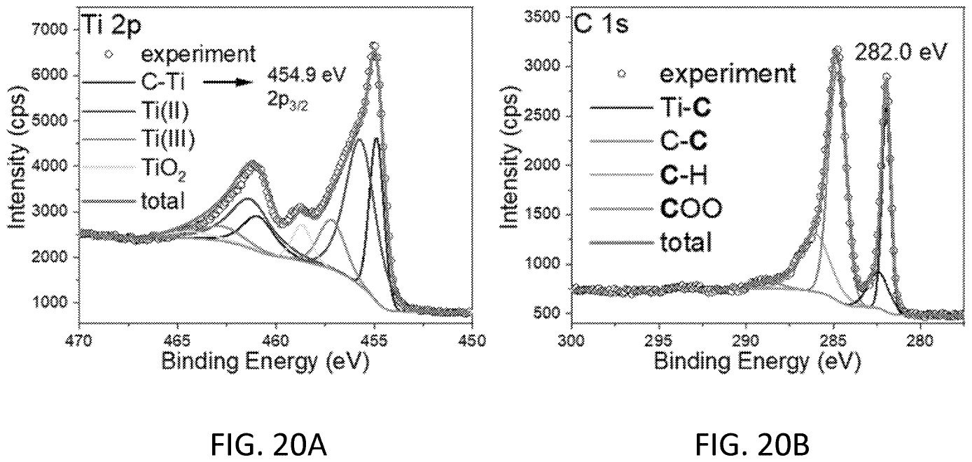

The reactions of Ti₃C₂Br₂ and Ti₂CBr₂ with LiH at 300° C. resulted in bare Ti₃C_{2□2} (FIG. 1E and FIGS. 18A-18D) and Ti₂C_{□2} MXenes (FIGS. 21A-21C), where stands for the vacancy site. Since H-terminations are difficult to reveal by STEM and other methods, this conclusion was based on the experimental value of the center-to-center distance between the Ti₃C₂ sheets (7.59 Å), which was substantially smaller than the theoretical prediction for Ti₃C₂H₂ MXene (8.26 Å) and close to the smallest theoretically possible spacing of 7.23 Å. Since XPS shows reduction of Ti after removal of the hydride groups (FIGS. 20A-20B), this process can be formally described as a reductive elimination step following the exchange reaction.

The chemical transformations of solids are generally impeded by slow diffusion, which severely limits the scope of synthesizable solid-state compounds. The complete exchange of surface groups in stacked MXenes was also expected to be kinetically cumbersome, especially if the entering ions are bulkier than the leaving ones, as in the case of Cl⁻ (the ionic radius, Rᵢ=1.81 Å) exchanged for Te²⁻ (Rᵢ=2.21 Å). Counterintuitively, the reactions of Ti₃C₂Cl₂ and Ti₂CCl₂ MXenes with O²⁻, S²⁻, Se²⁻, and Te²⁻ occurred at similar temperatures and with comparable reaction rates.

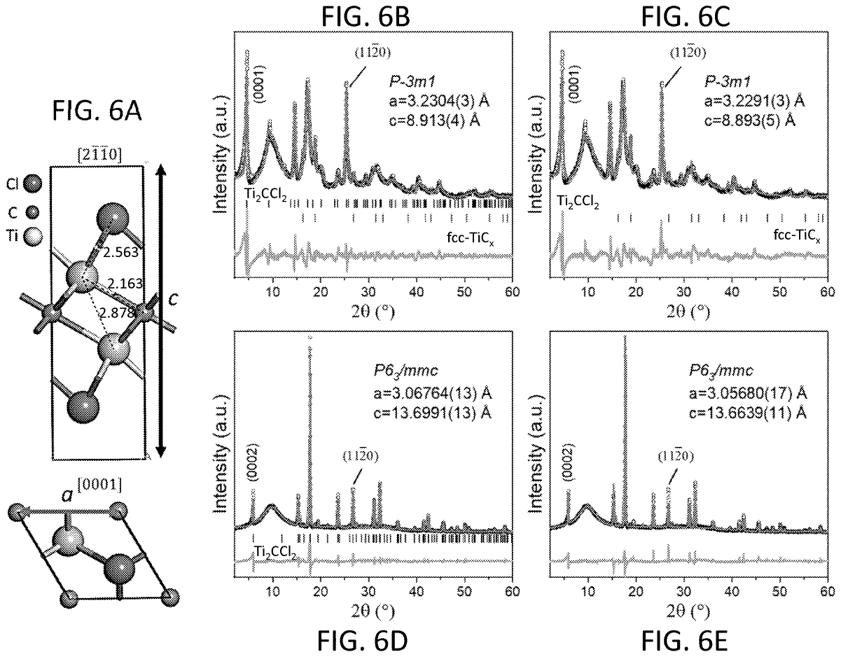

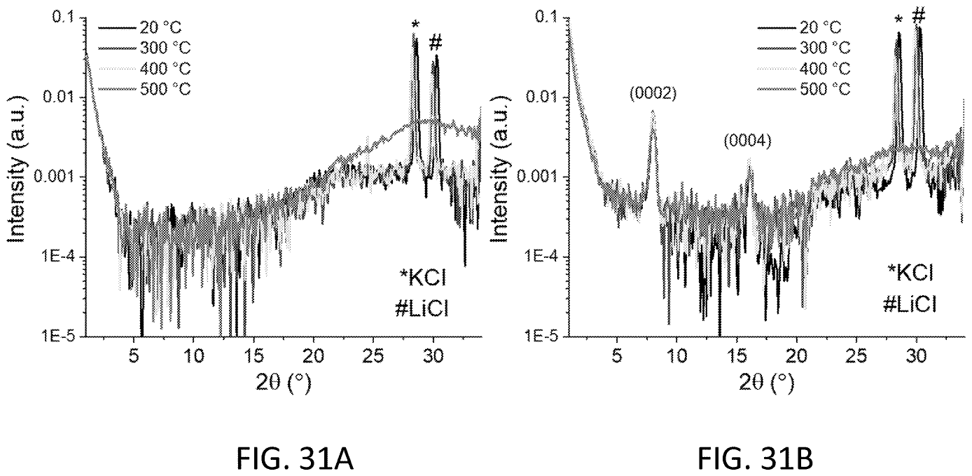

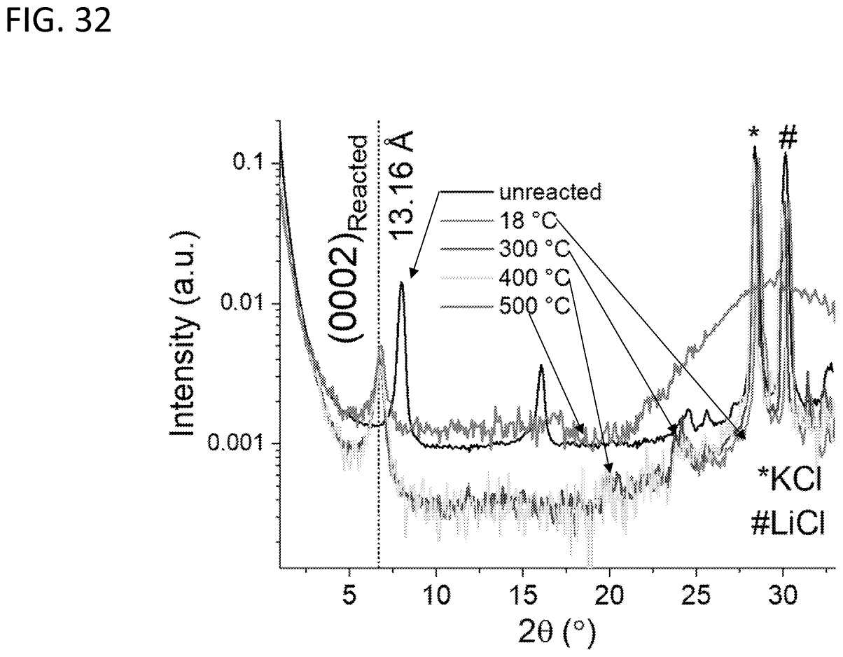

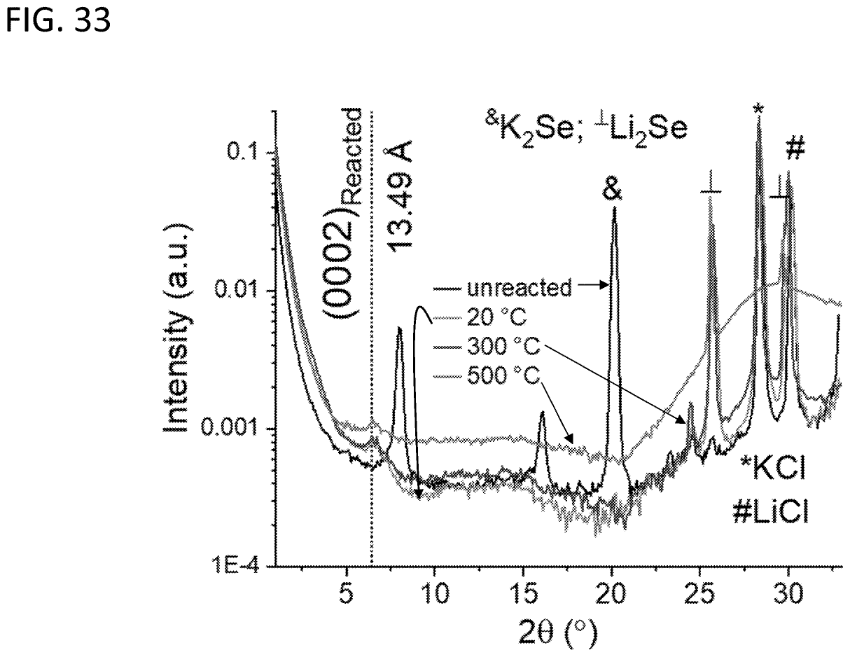

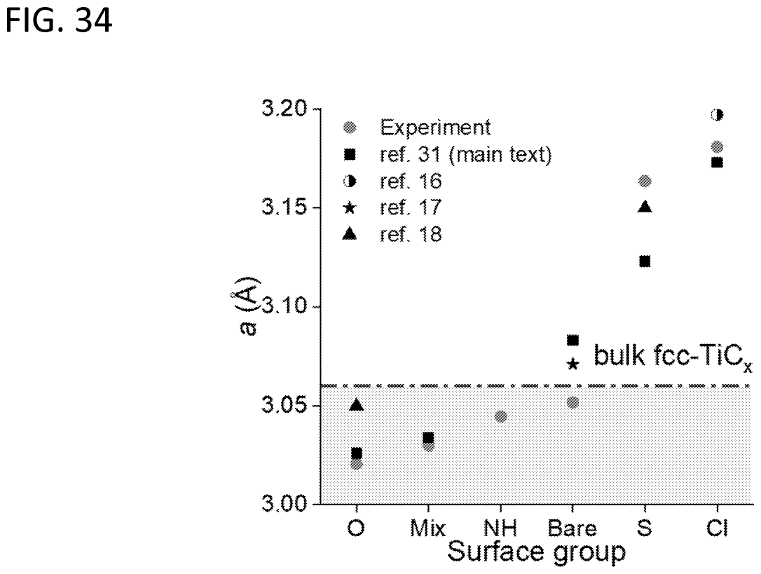

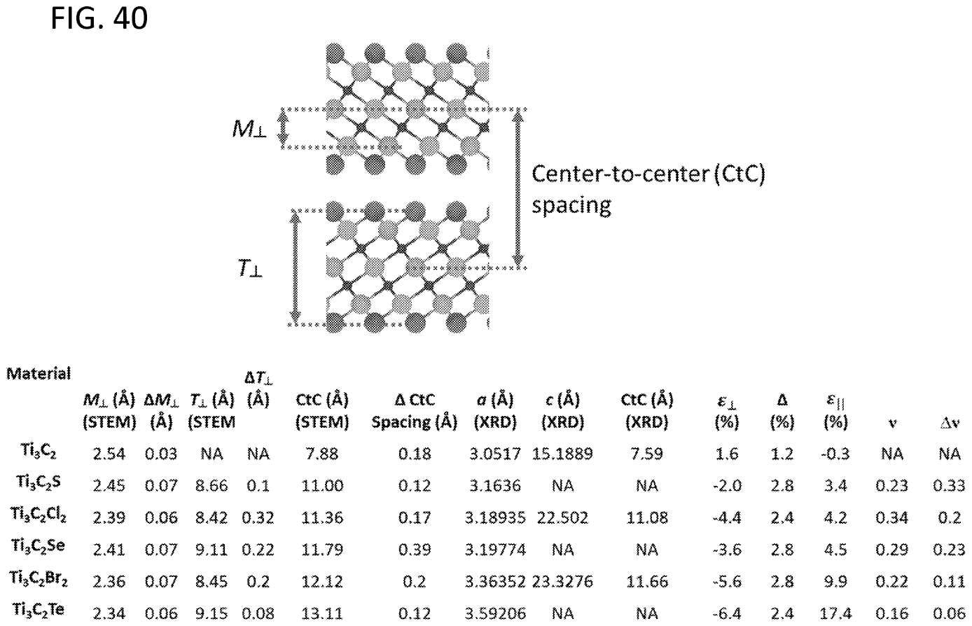

To understand this reactivity, the evolution of the (0002) diffraction peak corresponding to the center-to-center separation (d) between two adjacent MXene sheets was followed during surface exchange reactions. In the initial state, Ti₃C₂Cl₂ sheets formed stacks (FIGS. 6A-6E) with d=11.25 Å, and the van der Waals gap between MXenes is ~2.8 Å (FIG. 40), which is smaller than the dimensions of entering or leaving ions. No measurable changes of the d-spacing were detected upon heating Ti₃C₂Cl₂ in KCl—LiCl molten salt to 500° C. (FIGS. 31A-31B). However, heating MXene in the same molten salt but in the presence of Li₂O resulted in d=13.2 Å (FIG. 32), which corresponds to a 4.7-6.3 Å gap between the surface atoms on adjacent MXene sheets, depending on the local surface terminations. A similar d=13.5 Å was observed during reaction of Ti₃C₂Cl₂ MXene with Li₂Se, although with a larger disorder (FIG. 33). The unstacking of MXene sheets in molten salts greatly facilitates diffusion of ions and makes MXene surfaces sterically accessible. The interaction potential of MXenes in a molten salt is likely to be similar to the interactions between inorganic nanoparticles dispersed in molten salts. For two parallel surfaces, surface-templated ion layering in a molten salt leads to an exponentially decaying oscillatory interaction energy. It was speculated that the free energy released in the surface exchange reaction caused MXene sheets to “swell” into one of the energy minima and stay in this state during chemical transformation.

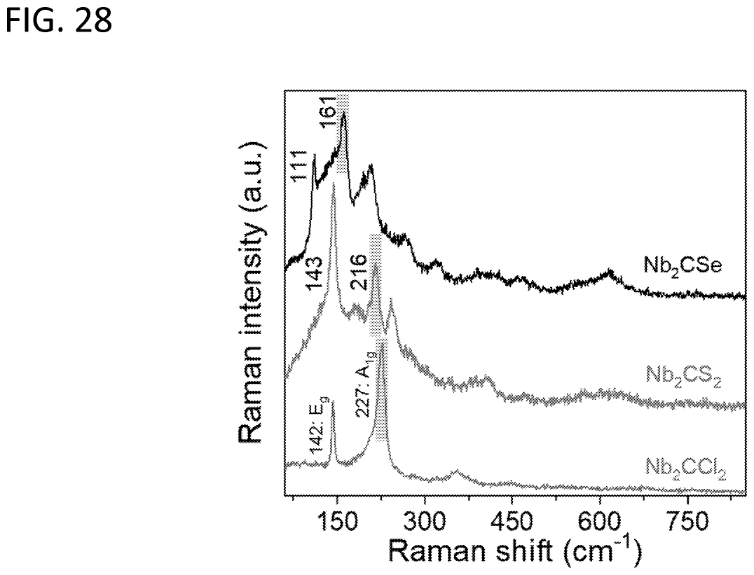

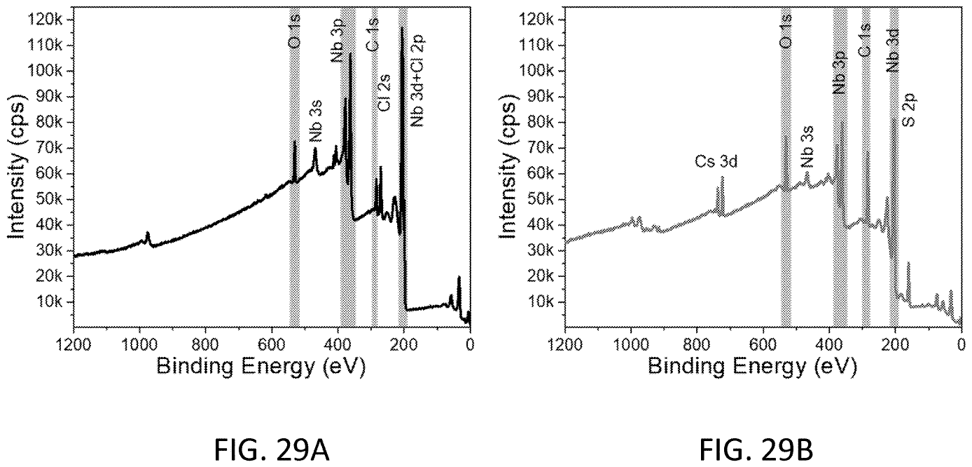

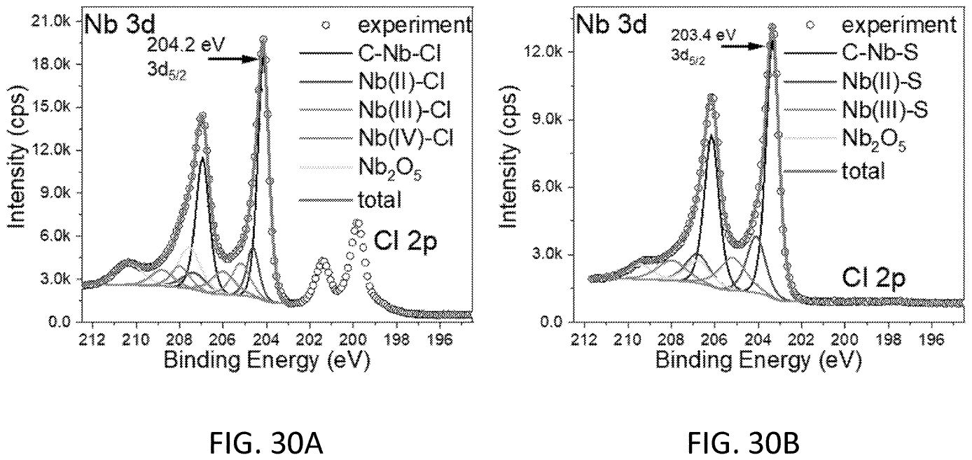

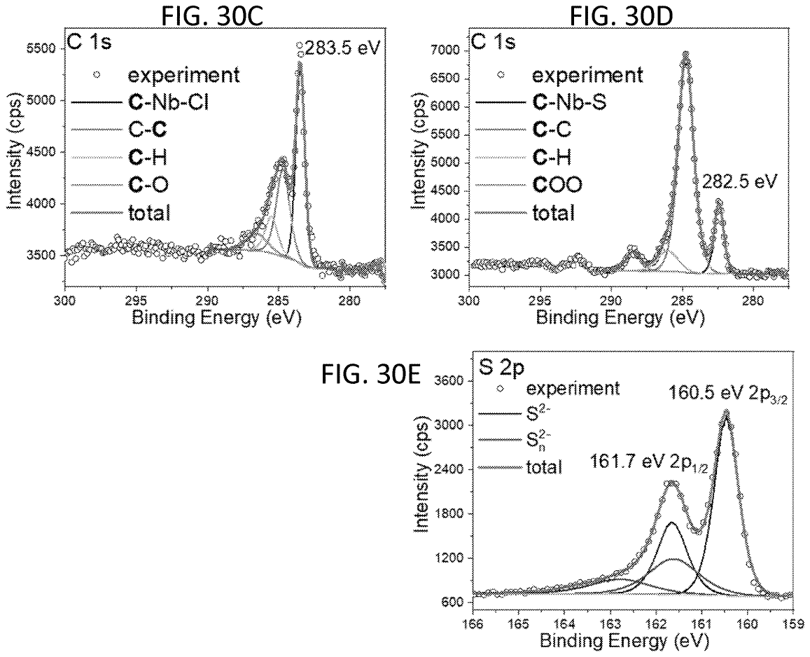

Moreover, the nature of the surface groups had an unusually strong impact on the MXene structure. The XRD patterns of Ti₃C₂Tₙ and majority of Ti₂CTₙ MXenes were modeled using the space group of the parent Ti₃AlC₂ and Ti₂AlC MAX phases (P6₃/mmc)=. Due to the simpler structure of thinner Ti₂CTₙ MXenes, their representative XRD patterns were further modeled using the Rietveld refinement. The fitting of the experimental Fourier-transformed EXAFS functions of Ti₂CTₙ MXenes (FIG. 2A) demonstrated that the local structure around Ti atoms was consistent with the respective crystallographic models. The real space interatomic PDFs, G(r), showed systematic shifts of Ti—T and Ti—Ti2 distances to larger values in S to Te series of Ti₂CTₙ MXenes (FIG. 2A). In MXenes, Ti—Ti2 distance is equal to the nearest-neighbor distance between Ti atoms in the basal (0001) plane and hence it represents the in-plane a lattice constant (FIGS. 2B, 2C). For example, for Ti₂CBr₂ the Rietveld, EXAFS, and PDF methods converged on a=3.32 Å. After exchanging Br for O²⁻, the resultant MXene showed a=3.01 Å, and the reaction with Te²⁻ produced MXene with a=3.62 Å (FIG. 2C). The simulated XRD patterns of Ti₂CTₙ MXenes suggest that large Te²⁻ groups are likely positioned on top of the neighboring Ti atoms (FIG. 2D, FIG. 28). This is distinctively different from the MXenes with smaller surface groups which are positioned between hexagonally-packed Ti surface atoms, on top of the opposite Ti atoms of the same Ti₂CTₙ sheet (FIG. 2B).

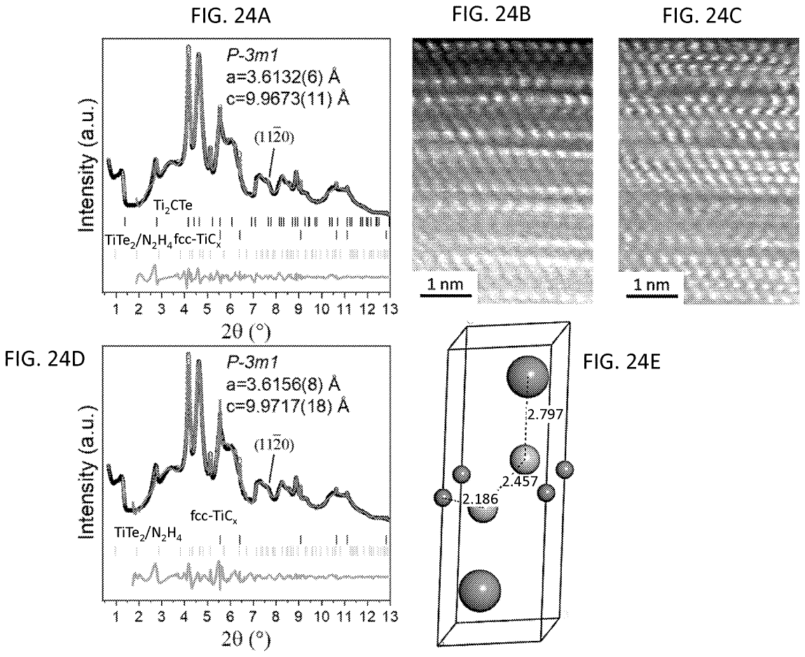

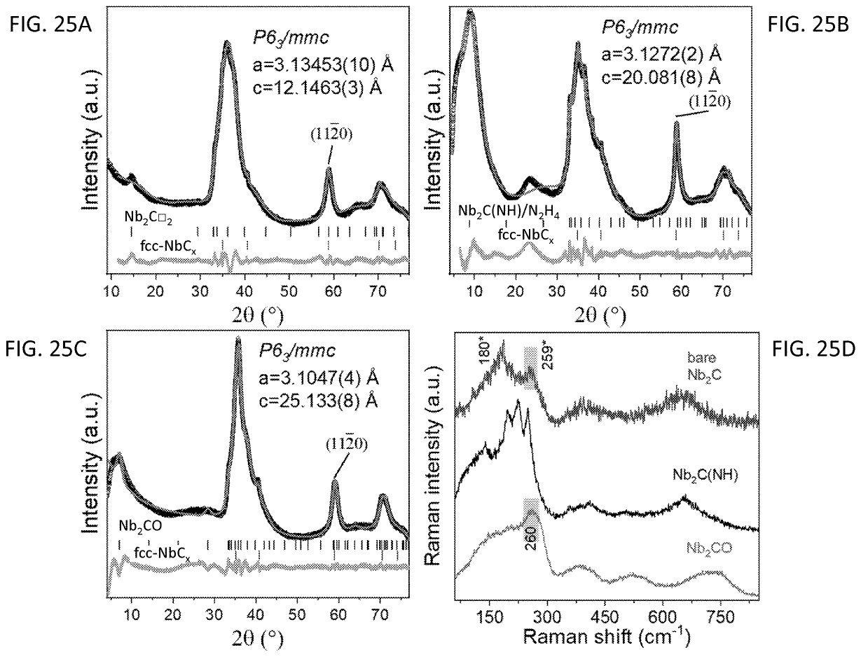

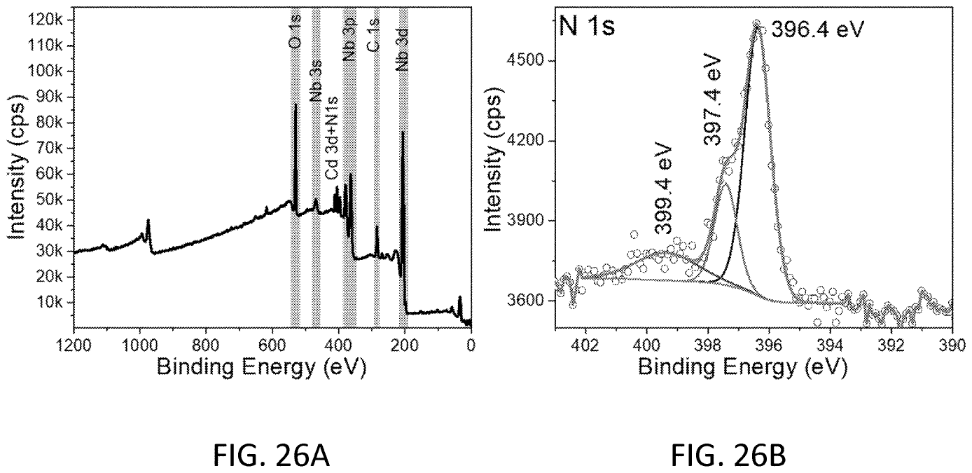

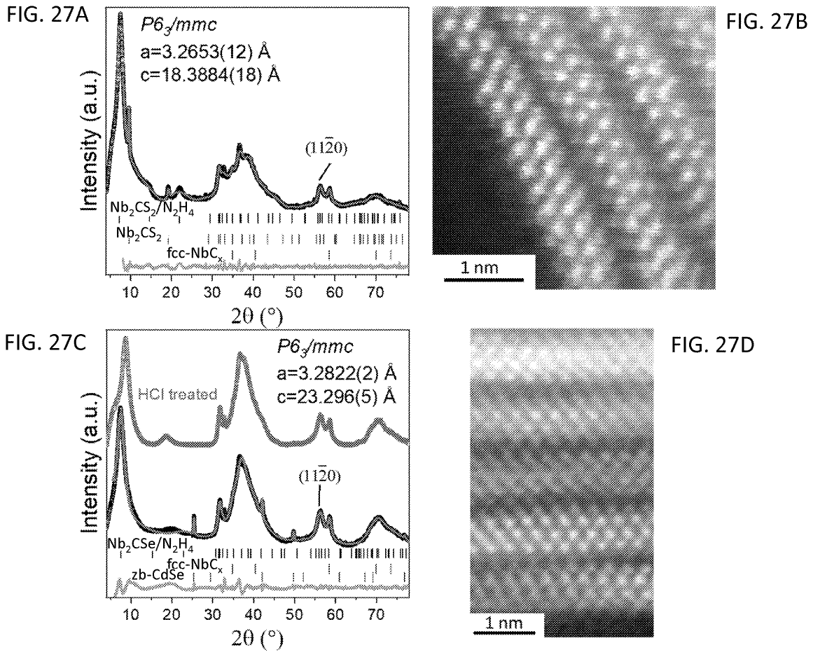

The vdW radii and packing density of surface atoms had a huge effect on a (FIG. 2C). For comparable ion radii, e.g., S vs. Cl and Se vs. Br, halido-terminated MXenes showed larger a, likely because of the smaller number of chalcogenide ions required for charge compensation of the MXene surface. To estimate the in-plane strain (a) imposed on the titanium carbide lattice by surface groups in the new MXene species, a was compared to the nearest-neighbor distance between Ti atoms in (111) plane of bulk cubic TiC that is structurally equivalent to the basal (0001) MXene plane. For Ti₃C₂ In and Ti₂CTₙ MXene families, the mixed (Tₓ=F, O, OH) and pure O²⁻ terminations resulted in a compressive ε_{∥}. Bare (□) and NH-terminated MXenes were nearly strain-free, whereas Cl, S, Se, and Br-terminated MXenes all had tensile ε_{∥}. The thinner Ti₂CT, MXenes had, on average, a slightly larger in-plane expansion or contraction with respect to the bulk TiC lattice, compared to the thicker Ti₃C₂ Tₙ MXenes. The Ti₂CTe MXene (FIGS. 2A, 2C and FIGS. 24A-24E) had the largest magnitude of tensile ε_{∥} of 18.2% in accordance with Te²⁻ having the largest vdW radius among all groups used in this example. This degree of lattice expansion in a crystalline solid is very unusual. For comparison, the lattice of bulk TiC expands by “only” 2.5% when heated from room temperature to 2700° C.

Since the out-of-plane (c) lattice constant is strongly affected by the intercalation of ions and solvent molecules between MXene sheets, high-resolution STEM images were used to assess the distances between the Ti planes along the c axis of the unit cell (FIG. 40). The magnitude of the out-of-plane strain in the MXene core (ε_{⊥}) can be calculated by referencing experimental distances between Ti planes inside the MXene sheets (M1) to the distance between the (111) planes of bulk TIC (FIG. 40). FIG. 2E shows that the expansion of the a-lattice parameter in Ti₃C₂Tₙ MXenes functionalized with S, Cl, Se, Br, and Te atoms is accompanied by the corresponding contraction of the Ti₃C₂ layers along the c axis. This observation is consistent with the behavior of the Ti₃C₂ layers as an elastic 2D sheet under biaxial stress imposed by the surface atoms (FIG. 2E). The Poisson effect can account for the relations between the stress and the strain components reflected by observed changes of a and M_{⊥} distances. Unfortunately, the atomic-resolution STEM images of MXenes measured M_{⊥} values with relatively large error bars (due to projection effects and bending of the MXene sheets) which complicated an accurate estimation of the Poisson's ratio (v) for new MXenes. A simple elastic model applied to Ti₃C₂ Tₙ yielded v~0.22 for T=S and Br. On the other hand, Ti₃C₂Te showed v=0.16±0.06, likely due to the additional stiffening of the Ti₃C₂ layers under very large in-plane stress.

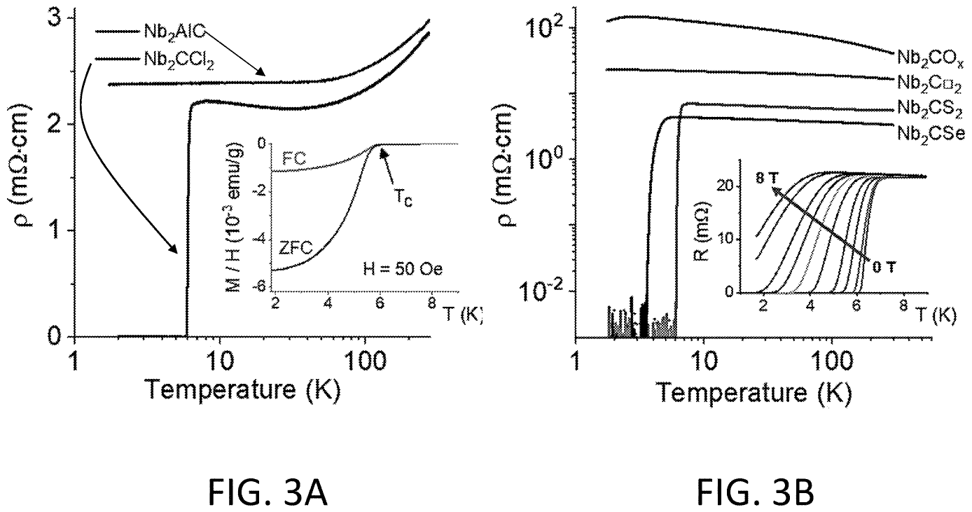

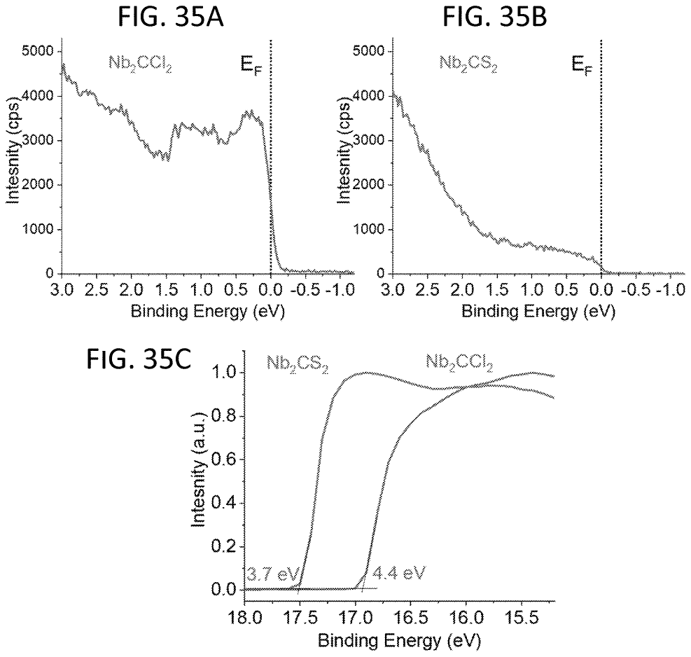

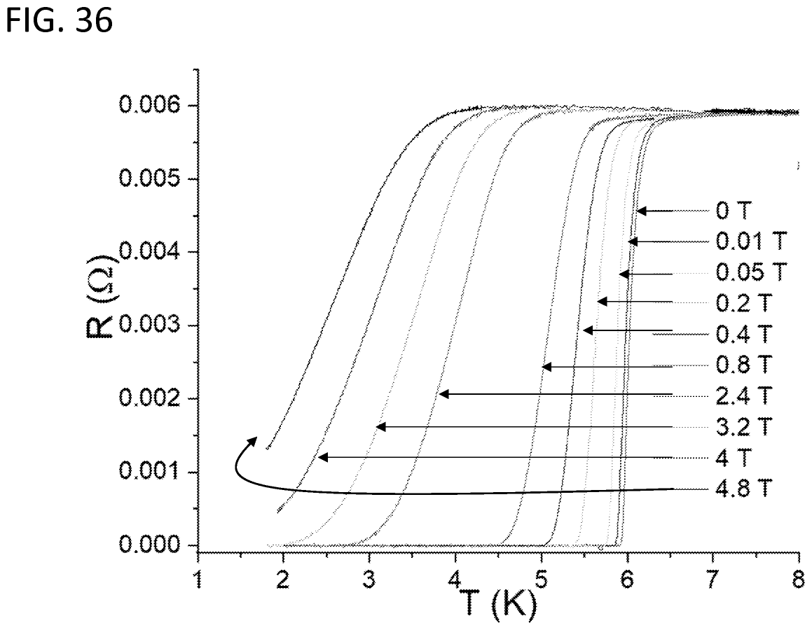

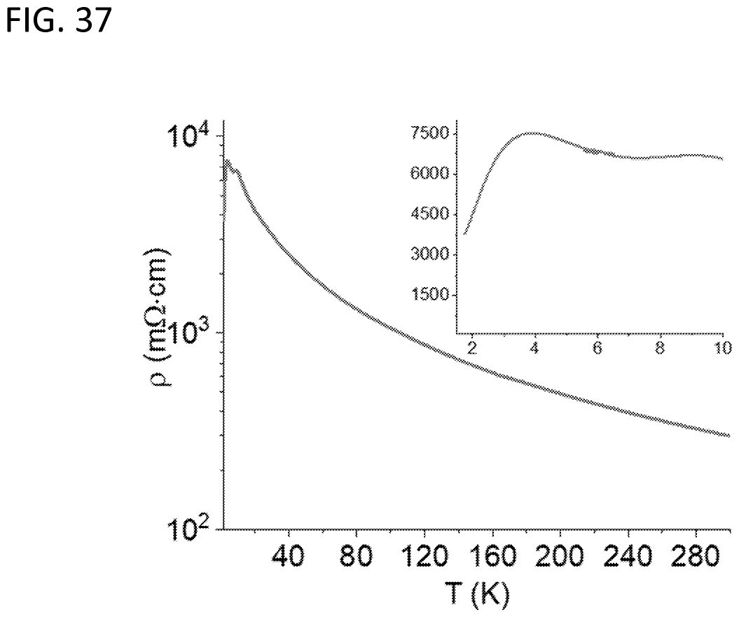

The above examples show that the composition and structure of MXenes can be engineered with previously unattainable versatility. Next, this example shows that the surface groups define the nature of electronic transport in Nb₂CTₙ MXenes. FIGS. 3A-3B show temperature-dependent four-probe resistivity (p) measured on cold-pressed pellets of Nb₂CTₙ (T=o, Cl, O, S, Se) MXenes, all synthesized by the procedures described herein. FIG. 3A also compares the conductivity of the parent Nb₂AlC MAX phase with that of Nb₂CCl₂ MXene. Above 30 K, both MAX phase and MXene samples show similar specific resistivity, which decreased when the sample was cooled. Such behavior is often associated with metallic conductivity. The ultraviolet photoelectron spectroscopy (UPS) confirms nonzero density of electronic states at the Fermi energy E_{F} (FIGS. 35A-35C), which is consistent with the metallic behavior. When the Nb₂CCl₂ MXene was cooled below 30 K, the resistivity started increasing, possibly due to the beginning of localization. This was followed by a sharp drop of resistivity by several orders of magnitude at a critical temperature T_{c}~6.0 K (FIG. 3A), which is reminiscent of a superconductive transition. The magnetic susceptibility measurements show the development of a strong diamagnetism below 6.3 K interpreted as the Meissner effect. From the magnitude of zero-field-cooled data at 1.8 K, the lower bound was estimated for the superconducting volume fraction of Nb₂CCl₂ MXene as ~35%. Consistent with superconductivity, the transition broadened, and T_{c} shifted to lower temperatures with the application of external magnetic field (FIG. 36). In contrast, the parent Nb₂AlC MAX phase behaved as a normal metal down to the lowest measured temperature (1.8 K). To the best of the inventors' knowledge, this is the first experimental observation of superconductivity in top-down fabricated MXenes. For reference, Nb₂CTₓ MXene with mixed O, OH, F termination prepared by the traditional aqueous HF etching route showed two orders of magnitude higher resistivity and no superconductivity (FIG. 37).

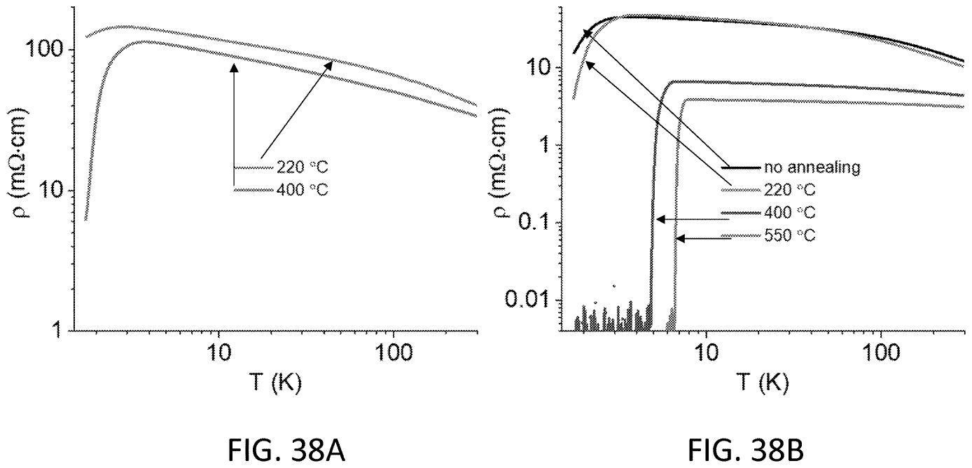

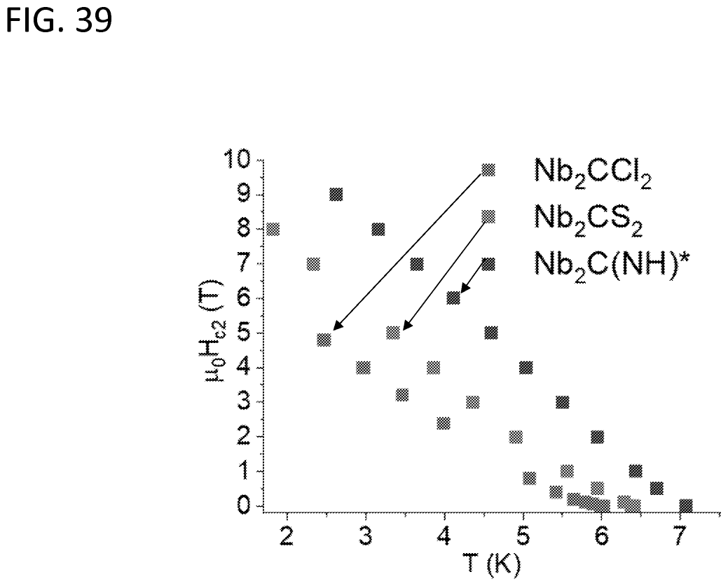

In contrast to Nb₂CCl₂ MXene, the resistivity of MXenes terminated with chalcogenide ions (O, S, Se) gradually increased when the sample was cooled (FIG. 3B), consistent with the activated transport regime. Since UPS shows the finite density of states at E_{F} in Nb₂CS₂ (FIGS. 35A-35C), it is reasonable to hypothesize that the localization is controlled by the tunneling rates for charge carriers between metallic MXene sheets. The oxo-terminated Nb₂CTₙ MXene shows the highest, and the seleno-terminated MXene the lowest resistivity, consistent with the reduction of the tunneling barrier heights between the MXene sheets. In the low-temperature region, superconducting transitions were observed in Nb₂CS₂ (T_{c}~6.4K), Nb₂CSe (T_{c}~4.5 K), and Nb₂C(NH) (T_{c}~7.1 K, FIGS. 38A-38B), while Nb₂CO did not enter the superconducting state (FIGS. 38A-38B). In granular metals, the development of macroscopic superconductivity can be suppressed by weak coupling of individual superconducting domains, which is also reflected by the high resistivity in the normal state. The upper critical field (μ₀H_{c2}) shows strong dependence on the surface functional group. For example, Nb₂CS₂ MXene exhibits higher μ₀H_{c2} compared to Nb₂CCl₂ (FIG. 3B, inset, and FIG. 39). Interestingly, bare Nb₂C_{□2} MXenes showed no transition to the superconducting state down to 1.8 K (FIG. 3B). This demonstrates that the surface groups are not spectators but active contributors to the MXene superconductivity.

### Experimental Section

### Chemicals and Materials

Al powder (99.5%, 325 mesh, Alfa Aesar), C (graphite, 99.8%, 325 mesh, Alfa Aesar), Ti powder (99.5%, 325 mesh, Alfa Aesar), Nb₂AlC (200 mesh, Forsman Scientific), KCl (99.95%, ultra dry, Alfa Aesar), NaCl (99.99%, ultra dry), CdCl₂ (99.996%, ultra dry, Alfa Aesar), ZnCl₂ (99.999%, ultra dry, Alfa Aesar), CdBr₂ (99.999%, ultra dry, Alfa Aesar), CsBr (99.9%, ultra dry, Alfa Aesar), KBr (99.9%, ultra dry, Alfa Aesar), LiBr (99.9%, ultra dry, Alfa Aesar), LiCl (99.995%, ultra dry, Alfa Aesar), LiH (99.4%, Alfa Aesar), NaNH₂ (99%, extra pure, Acros Organics), Li₂O (99.5%, Alfa Aesar), Li₂S (98%, Strem), N₂H₄ (98%, anhydrous, Sigma), HCl (36.5-38%, Fisher), HBr (48%, Sigma), MeCN (99.8%, anhydrous, Sigma), MeOH (99.8%, anhydrous, Sigma), LiF (98.5%, Alfa Aesar), HF (48%, Sigma). Alumina crucibles were 99.8% grade from CoorsTek. Borosilicate glass capillaries were 0.5 mm in diameter and 10 μm wall thickness from Hampton Research.

Li₂Se and Li₂Te were synthesized according to Owen's method. (A. N. Beecher et al., J. Am. Chem. Soc. 136, 10645-10653 (2014).) In order to avoid oxidation of MXenes at high temperatures, it is paramount that the alkali metal chalcogenide precursors do not contain polysulfides, polyselenides, and polytellurides.

### MAX Phase Synthesis

Ti₃AlC₂ MAX phase was synthesized from TiC, Ti, and Al according to a well-established procedure described in detail elsewhere. (M. Alhabeb et al., Chem. Mater. 29, 7633-7644 (2017).) Ti₂AlC MAX phase was synthesized using the modified molten salt approach. (M. Li et al., J. Am. Chem. Soc. 141, 4730-4737 (2019).) In brief, Ti (0.356 g), C (0.045 g), and Al (0.12 g) (2:1:1.2 molar ratio) powders were mixed with NaCl (0.87 g) and KCl (1.109 g) salts using mortar and pestle. The resultant mixture was heated in an alumina crucible at 1080° C. for 2 h under the flow of Ar.

Synthesis of MXenes with Mixed (F, OH, O) Termination

Mixed terminated Ti₃C₂Tx were synthesized by etching Ti₃AlC₂ MAX phase in aqueous LiF—HCl solution as described in detail elsewhere. (Alhabeb, 2017.) Mixed terminated Nb₂CTₓ MXenes were synthesized by etching Nb₂AlC MAX phase in 48 wt. % HF as described in detail elsewhere. (M. Naguib et al., J. Am. Chem. Soc. 135, 15966-15969 (2013).)

### Synthesis of Cl- and Br-Terminated MXenes

Molten salt-based etching of MAX phases and surface group substitution/elimination reactions were all performed in an Ar-filled glovebox with oxygen and moisture levels below 1 ppm unless stated otherwise.

Ti₃AlC₂ (0.5 g) and Ti₂AlC (0.346 g) MAX phases were mixed with CdCl₂/CdBr₂ salts in 1:8 molar ratio using mortar and pestle. The resultant mixture was heated in an alumina crucible at 610° C. for at least 6 h. Nb₂AlC MAX phase (0.578 g) was mixed with CdCl₂ salt in 1:10 molar ratio using mortar and pestle. The resultant mixture was heated in an alumina crucible at 710° C. for 36 h. The Cl functionalized MXenes were recovered from the reaction mixture by dissolving excess CdCl₂ and Cd metal in concentrated HCl followed by washing with deionized (DI) water until neutral pH. The Br functionalized MXenes were recovered from the reaction mixture by dissolving excess CdBr₂ and Cd metal in concentrated HBr for at least 24 h followed by washing with DI water until neutral pH. The resultant MXene powders were dried under vacuum at 45° C. for >12 h for further use.

In case of the scaled-up synthesis of Nb₂CCl₂ MXene (>1 g of MXene powder), the recovered powder still contained unreacted Nb₂AlC MAX phase (as evidenced by XRD analysis). In order to increase the reaction yield, the product after 36 h of etching in CdCl₂ molten salt was recovered from the reaction mixture. The recovered powder containing Nb₂CCl₂ MXene and unreacted Nb₂AlC MAX phase was mixed with new CdCl₂ salt and further annealed at 710° C. for another 36-48 h.

### Substitution/Elimination of Cl/Br Surface Groups

The Cl- and Br-terminated MXenes acted similarly during the substitution/elimination reactions. In a typical reaction procedure, Ti₃C₂Br₂ MXene (70 mg) was stirred in CsBr/KBr/LiBr (25:18.9:56.1 molar ratio, m.p. 236° C.) eutectic (1.777 g) at 300° C. for 60 minutes in an alumina crucible using a glass coated stir bar. At least 3 times mole excess of the reactive ionic compound was further added to the MXene/salt mixture and stirred at 300° C. In the case of LiH and NaNH₂, the elimination and surface functionalization with NH, respectively, were complete after 2 h of stirring at 300° C. In the case of Li₂O, Li₂S, Li₂Se, and Li₂ Te, the stir bar was first removed with a magnet before annealing the reaction mixture at 500-550° C. (functionalization with S, Se, and Te) or 600° C. (functionalization with O) for 12-24 h in a muffle furnace. All products were recovered by dissolving the salt matrix in anhydrous N₂H₄ followed by washing with anhydrous MeCN and anhydrous MeOH inside a N₂ filled glovebox in order to avoid possible oxidation of the surface groups, especially chalcogenide groups.

The amounts used in this work were not optimized, and the MXene/molten salt ratio can be increased in order to reduce the cost of using ultra dry salts per surface functionalization reaction. For example, in the case of the scaled-up conversion of Nb₂CCl₂ MXene to Nb₂CS₂ MXene (required for pressing a pellet), the MXene concentration in CsBr/KBr/LiBr eutectic was as high as 122 mg/g, yielding ~600 mg of Nb₂CS₂ MXene product per synthesis.

Delamination of Ti₃C₂Tₙ MXenes

In a typical delamination process, 500 mg Ti₃C₂Cl₂ was immersed in 5 mL of 2.5 M n-butyllithium hexanes solution in a sealed vial. Then, the mixture was stirred at 50° C. for 24 h inside N₂ filled glovebox. The lithium intercalated MXene was washed with hexane followed by tetrahydrofuran (THF) to remove excess lithium and organic residues. After that, 100 mg of intercalated powder and 10 mL anhydrous N-methylformamide (NMF) were added in a centrifuge tube which was further sealed inside N₂ filled glovebox. After bath sonication (<10° C. to avoid possible oxidation) for 1 h, the supernatant was collected by centrifuging at 1500 r.p.m. for 15 min. Finally, the supernatant was centrifuged at 9000 r.p.m. for 15 min to remove small impurities. The sediment was further redispersed in fresh NMF or hydrazine to form stable colloidal solutions. A similar procedure was used for the delamination of Ti₃C₂S and Ti₃C₂NH MXenes.

### Thin Film Fabrication

Glass substrates were treated in piranha solution (H₂SO₄: H₂O₂=5:2) for 30 min, and thoroughly washed with DI water and treated with oxygen plasma for 30 min. The MXene film was obtained by spin-coating colloidal Ti₃C₂Cl₂ in NMF on a substrate at ~ 90° C. inside a N₂ filled glovebox.

### In-Situ WAXS Experiment

Due to the high attenuation coefficient of Cu Kα X-rays by CsBr salt (995.8 cm⁻¹), a mixture of KCl (245 cm⁻¹) and LiCl (178.4 cm⁻¹) in 1:2 molar ratio was used instead. Ti₃C₂Cl₂ MXene was mixed with KCl/LiCl salt at a 100 mg/g concentration (mixture 1). In case of the surface group substitution, 3 times mole excess of Li₂O or K₂Se (w.r.t. Ti₃C₂Cl₂ MXene) was added to mixture 1 above (mixture 2). The resultant mixture (mixture 1 or mixture 2) was annealed at 500-550° C. in an alumina crucible for 12-24 h. The annealed mixture was crushed with mortar and pestle, and the fine powder was loaded into 0.5 mm borosilicate glass capillary. The capillary was first sealed with epoxy inside the nitrogen filled glovebox before flame sealing outside the glovebox. The in-situ heating experiments were performed in the Linkam stage. The heating rate was 10 K/min, and the capillary was allowed to equilibrate for an additional 20 minutes before the measurement.

### Characterization Techniques

### XRD

The diffraction patterns in the reflection mode were obtained using a Bruker D8 diffractometer equipped with Vantec 2000 area detector using Cu Kα X-ray source (1.5418 Å) operating at 40 kV and 40 mA.

Representative samples of Ti₂CTₙ MXenes such as Ti₂CCl₂, Ti₂CBr₂, Ti₂CS and Ti₂AlC MAX phase were additionally collected in spinning capillary in the transmission mode using monochromatic Mo Kal radiation (0.7093 Å, STOE Stadi-MP). Synchrotron radiation (0.2412 Å, Advanced Photon Source, 17-BM-B) was used to measure Ti₂CTe sample (due to its strong absorption of Mo Kal radiation).

XRD full pattern fittings (Le Bail and Rietveld) were performed using TOPAS Version 5 software. The Le Bail full pattern fitting was used to extract the unit cell parameters. Each MXene and MAX phase sample was assumed to contain at least two phases: MXene (P6₃/mmc or P-3 ml space group) or MAX phase (P6₃/mmc space group) and TiCₓ or NbCₓ (Fm-3m space group) minor impurity phase typically present in the corresponding MAX phases. The Stephens model (hexagonal symmetry) was used to account for the anisotropic peak broadening of the XRD patterns of MXenes and MAX phases. The Rietveld refinement of the MXene XRD patterns collected in the reflection mode was impeded by the high anisotropy of the MXene samples due to their 2D nature, and the lack of precise ordering in third dimension. Moreover, Rietveld analysis can completely fail for 2D MXenes systems such as recently shown for MO₂CTₓ MXene. The differences between the Le Bail and Rietveld refinements were insignificant and within approximately 0.01 Å for a and 0.1 Å for c lattice constants.

Simulated XRD patterns for three different configurations of surface groups in Ti₂CCl₂ and Ti₂CTe MXenes were generated in BIOVIA's Materials Studio program.

### Waxs (Transmission)

Transmission WAXS patterns of the MXenes in salt matrices were collected on a SAXSLab Ganesha instrument with Cu Kα X-ray source (1.5418 Å).

### X-Ray Total Scattering and Pair Distribution Function (PDF) Analysis

The pair distribution function, G(r), gives the probability of finding a pair of atoms separated by a distance r. High energy X-ray total scattering experiments were performed at 11-ID-B at the Advanced Photon Source, with the X-ray wavelength of 0.2115 Å. The raw 2D data were azimuthally integrated and reduced to 1D intensity versus 20 in GSAS-II using CeO₂ powder for the calibration to determine sample to detector distance. PDFgetX2 program was used to correct and normalize the diffraction data and then Fourier transform the reduced structure factor to obtain the PDF, G(r), according to:

$$G ( r ) = \frac{2}{π} {\int }_{{q}_{min}}^{{q}_{max}} dqq ( S ( q ) - 1 ) sin ( qr )$$

where q is the magnitude of the scattering momentum transfer and S (q) is the properly corrected and normalized powder diffraction intensity measured from qₘᵢₙ and qₘₐₓ.

### X-Ray Absorption (XAS)

Extended X-ray Absorption Fine Structure (EXAFS) spectroscopy and X-ray Absorption Near Edge Structure (XANES) were employed to probe the local environment around Ti using K-edge EXAFS and XANES (4966 eV) and around Nb using K-edge XANES (18999 eV) at the 20-ID-B beam line at the Advanced Photon Source, Argonne National Laboratory. XAS data were collected in the transmission mode at room temperature. The incident, transmitted, and reference X-ray intensities were monitored using gas ionization chambers. A titanium/niobium foil standard was used as a reference for energy calibration and was measured simultaneously with experimental samples. All powder samples were measured as pellets diluted with appropriate amount of BN and sealed in Kapton tape inside a glovebox.

Data collected were processed using Athena software (version 0.9.26) by extracting the EXAFS oscillations χ(k) as a function of photoelectron wave number k. The theoretical paths were generated using FEFF6 and the models were fitted using the Artemis software (version 0.9.26). Data sets were simultaneously fitted in the R-space with k-weights of 1, 2 and 3.

Additional fitting details: Incorporation of two scattering Ti—Ti paths for Ti₂CTₙ samples was essential to get a good fit in the area between 2-3 Å in R space. The first scattering Ti—Ti path (Ti—Ti1) corresponds to the nearest neighbor Ti on the opposite side of the same Ti₂CTₙ 2D sheet. The second scattering Ti—Ti path (Ti—Ti2) corresponds to Ti neighbor on the same side of the same Ti₂CTₙ sheet. Ti—Ti2 distance is approximately equal to the in-plane lattice constant a determined from XRD.

### STEM Characterization

Atomic-resolution characterization of the MXene samples was conducted using the JEOL ARM200CF at the University of Illinois at Chicago, which is an aberration-corrected scanning transmission electron microscope (STEM) equipped with a cold field emission gun operated at 200 kV, a Gatan Continuum electron energy-loss spectrometer (EELS) and an Oxford XMAX100TLE X-ray detector, providing a sub-Å probe-size and 350 meV energy resolution. The emission current was reduced to 12 μA in order to reduce damage from the electron beam. An electron probe convergence semi-angle of 24 mrad was used and the inner detector angle for high angle annular dark field imaging was chosen to be 75 mrad, while an inner angle for low angle annular dark field (LAADF) imaging was chosen at 30 mrads.

The MXene samples were initially prepared for STEM analysis by dropcasting particles suspended in isopropyl alcohol onto a 3 mm holey-carbon covered TEM grid. The chalcogenide functionalized MXenes still contained intercalated N₂H₄, which required heating the samples to 100° C. prior to performing the STEM characterization. The samples were heated using the Protochip Aduro Double Tilt heating holder in the column of the JEOL ARM200CF.

### SEM-EDX

SEM imaging and EDX elemental mapping were performed in a TESCAN LYRA3 field-emission scanning electron microscope equipped with two X-Max-80 silicon drift x-detectors (SDD).

### Raman Spectroscopy

Raman spectra were obtained with a Horiba LabRamHR Evolution confocal microscope. Si (111) wafer was used for calibration. The samples were excited using a 633 nm light source operating at 1% of its power or a 532 nm light source operating at 2.5% of its power and using 100× long path objective and a 600 mm-1 grating.

### XRF

XRF analysis was performed with a benchtop Energy Dispersive Rigaku NEX DE VS X-ray fluorimeter equipped with a Peltier cooled FAST SDD Silicon Drift Detector. All analyses were carried out under He atmosphere to increase sensitivity for lighter elements. Elemental ratios were determined using the standardless thin films fundamental parameters method as programmed in QuantEZ software provided by Rigaku, using the standard Rigaku calibration protocols. For the consistent analysis, the samples were prepared by drop casting powders dispersed in anhydrous MeOH on a Si substrate of an approximate 1 by 1 cm square size to provide uniform thin films throughout the series. The films were loaded into the instrument and the analysis window was set at 10 mm radius. All samples were measured and analyzed in the same manner. Pressed pellets of Nb₂CCl₂, Nb₂CS₂ and Nb₂CSe MXenes (prepared for resistivity measurements) were additionally measured using the pellet fundamental parameters method. The results were the same as in the case of the thin films fundamental parameters method.

### Temperature Dependent Resistivity

Dried powders of MXenes were pressed under the load of ~ 55 MPa into square pellets of 13 mm in length or disks of 15 mm in diameter and 0.7-1 mm in thickness. Nb₂CS₂ and Nb₂CSe MXene pellets were additionally dried at 100-120° C. under 10-5 mbar for 12 h to get rid of excess N₂H₄. Nb₂COₓ and Nb₂C(NH) MXene pellets were additionally annealed at 220-550° C. under vacuum to investigate the effect of thermal post processing on the superconducting properties, if any (see FIGS. 38A-38B for details).

4 gold plated spring-loaded electrodes positioned in-line 2 mm apart were used to electrically contact the MXene pellet to a puck. The puck was then loaded into a physical property measurement system (PPMS, Quantum design) under He-filled inert atmosphere. The 4-probe resistivity measurements were carried out in an AC mode with a DC excitation of 1 mA. The temperature dependent resistivity measurements were performed from 300 K to 1.8 K.

### XPS

XPS analysis was performed on a Kratos Axis Nova spectrometer using monochromatic Al Kα source (1486.6 eV). Te 3d, Ti 2p, N 1s, C 1s, Nb 3d, Cl 2p, S 2p, and Br 3d high-resolution spectra were collected using an analysis area of 0.3×0.7 mm² and 20 eV pass energy with the step size of 100 meV. Charge neutralization was performed using a co-axial, low energy (~ 0.1 eV) electron flood source to avoid shifts in the recovered binding energy. C 1s peak of adventitious carbon was set at 284.8 eV to compensate for any remaining charge-induced shifts. Deconvolution of the high-resolution XPS spectra was performed in CasaXPS software using symmetric Lorentzian-Gaussian curves and a Shirley background. The Ti 2p region consisted of the two 2p_{3/2} and 2p_{1/2} spin-orbit split components. The peak area ratio of 2p_{3/2} to 2p_{1/2} was fixed to 2 to 1. The Ti 2p region was fit using 4 pairs of 2p_{3/2} and 2p_{1/2} components for each sample. The Nb 3d region consisted of the two 3d_{5/2} and 3d_{3/2} spin-orbit split components. The peak area ratio of 3d_{5/2} to 3d_{3/2} was fixed to 3 to 2. The Nb 3d region was fit using 5 pairs of 3d_{5/2} and 3d_{3/2} components for each sample. The Ti—C contribution of the C Is region was fit with the two curves in order to account for the peak asymmetry. The peak asymmetry was caused by the extrinsic loses due to delocalized states.

### UPS

UPS measurements were performed on a Kratos Axis Nova spectrometer using He I line (21.21 eV). Samples were in the form of the cold pressed pellets used for the resistivity measurements. During the measurements, a bias of −9 V was applied between the sample and the analyzer. The step size was 100 meV.

### Magnetization Measurements

Magnetic measurements were performed on a Quantum Design MPMS 3 instrument equipped with a superconducting quantum interference device (SQUID). Corrections were made for the diamagnetic contributions from the polycarbonate capsules and eicosane was used to secure the sample. From the zero-field-cooled curve of Nb₂CCl₂ MXene, the magnetic susceptibility at 1.82 K was −0.00529 emu/(g·Oe) (FIG. 3A). Given the crystallographic density is 5.3 g/cm³, the diamagnetic volume fraction was estimated as 0.00529*5.3*4π*100%=35.2%.

### Zeta Potential and Dynamic Light Scattering (DLS)

Zeta potential and DLS of a dilute filtered solution of Ti₃C₂Cl₂ MXene in NMF was measured with a Zetasizer Nano-ZS (Malvern Instruments). The sample was held in a glass cuvette with an immersed dip cell equipped with palladium electrodes.

### Estimation of the Interlayer Spacing Between MXene Sheets in Salt Matrix

The interlayer distance between Ti₃C₂Cl₂ MXene sheets after their reaction with Li₂O in KCl/LiCl molten salt can be estimated as following. Analysis of the high-resolution STEM images of Ti₃C₂Cl₂ MXene stack (FIGS. 6A-6E) suggests that each layer is 8.42 (±0.32) Å thick (Table 2). Hence the van der Waals gap between adjacent Ti₃C₂Cl₂ MXene sheets is 11.25−8.42 (±0.32)=2.83 (±0.32) Å~2.8 Å. The van der Waals gap between adjacent Ti₃C₂₀ MXene sheets is similar to that of between Ti₃C₂Cl₂ MXene, 9.46−6.87=2.59 Å~2.6 Å. (Z. H. Fu et al., Phys. Rev. B 94, 104103 (2016); and N. Zhang et al., 2D Materials 5, 045004 (2018).) The (0002) peak in FIGS. 31A-31B results in the center-to-center distance of 13.16 Å. Hence the upper bound (assuming 100% reaction yield) on the interlayer distance (including the van der Waals gap) between adjacent Ti₃C₂O sheets in KCl/LiCl salt is 13.16-6.87=6.29 Å~6.3 Å. The lower bound (assuming no Cl substitution took place) on the interlayer distance (including the van der Waals gap) between adjacent Ti₃C₂Cl₂ sheets in KCl/LiCl salt is 13.16−8.42 (±0.32)=4.74 (±0.32) Å~4.7 Å.

As for the reaction with Li₂Se, the (0002) peak in FIG. 32 results in the center-to-center distance of 13.49 Å. Hence the lower bound (assuming 100% reaction yield) on the interlayer distance (including the van der Waals gap) between adjacent Ti₃C₂Se sheets in KCl/LiCl salt is 13.49−9.11 (±0.22)=4.38 (±0.22) Å~4.4 Å. The upper bound (assuming no Cl substitution took place) on the interlayer distance (including the van der Waals gap) between adjacent Ti₃C₂Cl₂ sheets in KCl/LiCl salt is 13.49-8.42 (±0.32)=5.07 (±0.32) Å~5.1 Å.

### Estimation of the Poisson Ratio

In order to estimate the Poisson ratio (v) for the MXene sheets, it was assumed that the sheet can be approximated as an elastic isotropic solid. S, Cl, Se, Br and Te result in the tensile stress of the MXene basal (0001) plane, σₓₓ=σ_{yy}=σ. The surface groups do not cause stress along the c-axis, σ_{zz}=0. The in-plane strain, εₓ=ε_{y}=ε_{∥}, and out-of-plane strain, ε_{zz}=ε_{⊥}, can be related to the tensile stress using the 3D Hooke's Law:

$${ε}_{\vert \vert} = \frac{1}{E} ( {σ}_{xx} - v ( {σ}_{zz} + {σ}_{yy} ) ) = \frac{1}{E} ( σ - v σ ) \qquad ( 1 )$$

$${ε}_{⊥} = \frac{1}{E} ( {σ}_{zz} - v ( {σ}_{xx} + {σ}_{yy} ) ) = \frac{1}{E} ( 0 - 2 v σ ) \qquad ( 2 )$$

From the above equations, the Poisson ratio can be expressed in terms of ε_{∥} and ε_{⊥}:

$$v = \frac{- {ε}_{⊥} / {ε}_{‖}}{2 - {ε}_{⊥} / {ε}_{‖}} \qquad ( 3 )$$

The in-plane strain can be calculated as following:

$${ε}_{‖} = \frac{a - {a}_{TiC} / \sqrt{2}}{{a}_{TiC} / \sqrt{2}} \qquad ( 4 )$$

where a is the MXene in-plane lattice constant as estimated from the Le Bail fit of the corresponding XRD patterns and a_{TiC} (=4.32 Å) is the lattice constant of cubic TiC.
The out-of-plane strain can be calculated as following:

$${ε}_{⊥} = \frac{{M}_{⊥} - a / \sqrt{3}}{{a}_{TiC} / \sqrt{3}} \qquad ( 5 )$$

where M_{⊥} is the distance between Ti planes along c-axis, equivalent to the distance between (111) planes in cubic TiC. This distance can be obtained from the analysis of the MXene high resolution STEM images (FIG. 40).

If the bonding between transition metal atoms and surface functional groups were purely ionic, 1 halide (charge −1) and 0.5 chalcogenide (charge −2) ion would be expected per every transition metal atom in the outer MXene layer. The results in Table 2 above agree with this simple argument. The deviations of the MXene surface group density from the canonical one surface group per every transition metal atom in the outer layer have been observed in mixed terminated Nb₂CTₓ and Ti₃C₂Tx MXenes. (J. Palisaitis et al., Nanoscale 10, 10850-10855 (2018); and I. Persson et al., 2D Materials 5, 015002 (2017).) The slight substoichiometry in the case of Br/Cl-terminated MXenes can be as a result of surface vacancies.

Expanding upon this Example, the inventors propose various novel MXene structures enabled by the combinations of etching and substitution reactions using Lewis acidic and Lewis basic molten salts, respectively.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A method of eliminating a surface termination of an MXene, the method comprising:
providing particles of a first MXene represented by a formula Mₘ₊₁CₘTₙ₁ and having a layered structure in which Mₘ₊₁Xₘ forms two-dimensional sheets, where Mis a transition metal, m is 1, 2, or 3, and Tₙ₁ denotes surface terminating chloride anions, bromide anions, iodide anions, or a combination thereof;
dispersing the particles of the first MXene in an alkali halide molten salt bath comprising an alkali chloride salt, an alkali bromide salt, an alkali iodide salt, or a eutectic thereof and containing solubilized hydride anions, whereby the hydride anions reductively eliminate the surface terminating chloride anions, bromide anions, or iodide anions to form a second MXene represented by a formula Mₘ₊₁C_{m□2} and having a layered structure in which Mₘ₊₁ Cₘ forms two-dimensional sheets, where M is a transition metal, m is 1, 2, or 3, and represents a surface vacancy site.

2. The method of claim 1, wherein m is 1 or 2.

3. The method of claim 1, wherein M is Ti, Nb, V, Ta, Cr, Mo, or Sc.

4. The method of claim 3, wherein Mis Ti.

5. The method of claim 4, wherein m is 1 or 2.

6. The method of claim 3, wherein M is Nb.

7. The method of claim 6, wherein m is 1 or 2.

8. The method of claim 1, wherein Tₙ₁ comprises the surface terminating bromide anions.

9. The method of claim 1, wherein Tₙ₁ comprises the surface terminating chloride anions.

10. The method of claim 1, wherein the metal salt bath comprises the eutectic of at least two of the alkali chloride salt, the alkali bromide salt, and the alkali iodide salt.

11. The method of claim 1, wherein the molten salt bath has a temperature of at least 300° C.

12. The method of claim 1, wherein the molten salt bath has a temperature in the range from 300° C.-700° C.

13. A two-dimensional titanium carbide having a formula Ti₃C₂Tₙ, a formula Ti₂CTₙ, or a formula Nb₂CTₙ, where T is O, S, Se, Te, or NH and n has a value from 1 to 2, or having a formula Mₘ₊₁CₘX₂, where M is a transition metal, X is a surface terminating bromide anion, and n has a value from 1 to 2, or having a formula Nb₂CCl₂.

14. The two-dimensional metal carbide of claim 13 having a formula Ti₃C₂Br₂, Ti₂CBr₂, or Nb₂CBr₂.

15. A method of making a halide anion surface-terminated two-dimensional metal carbide, the method comprising:
providing a hexagonal layered ternary transition metal carbide having a formula Mₘ₊₁ACₘ, where M is a transition metal, A is a metal element, X represents carbon, and m is 1, 2, or 3;
selectively etching an A layer of the hexagonal layered ternary transition metal carbide with a transition metal bromide salt in a molten mixture comprising two or more alkali metal halide salts.

16. The method of claim 15, wherein the transition metal bromide salt is CdBr₂ and the two-dimensional metal carbide is surface terminated with bromide anions.

17. The method of claim 16, wherein the hexagonal layered ternary transition metal carbide is Ti₃AlC₂ or Ti₂AlC and the halide surface-terminated two-dimensional metal carbide is Ti₃C₂Br₂ or Ti₂CBr₂.
